(19) United States
(12) Patent Application Publication
(10) Pub. No.: US 2026/0320717 A1
(43) Pub. Date: Oct. 15, 2026

(54) WEB-BASED APPLICATION FOR MANAGING ASSETS

(71) Applicant: Morgan, Lewis & Bockius LLP, Philadelphia, PA (US)

(72) Inventors: Rachelle DUBOW, Swampscott, MA (US); Joshua ROSENZWEIG, Portsmouth, RI (US); Kyle DUMONT, Boston, MA (US); Garrett MACK, San Francisco, CA (US); Jason DONAHUE, Philadelphia, PA (US); Que DANG, Doylestown, PA (US); Karen DIPIAZZA, Brooklyn, NY (US)

(21) Appl. No.: 19/697,248

(22) Filed: Jun. 3, 2026

Related U.S. Application Data
(63) Continuation of application No. PCT/US2024/058383, filed on Dec. 4, 2024.
(60) Provisional application No. 63/605,963, filed on Dec. 4, 2023.

(51) Int. Cl. G06Q 50/18

(52) U.S. Cl. CPC G06Q 50/184

(57) ABSTRACT

This application is directed to managing and visually displaying intellectual property portfolio data to a user. A server is communicatively coupled to a database and a client device via an application programming interface, and hosts an intellectual property-data web application including one or more intellectual property-specific user interfaces. The server receives a request from a client device. In response to the request, the server provides an intellectual property information user interface displaying selectable intellectual property data affordances and an interactive data visualization, which further includes independently selectable jurisdictions. In response to a user selection of a particular independently selectable jurisdiction on the interactive data visualization, particular intellectual property data are retrieved from the database and provided to the client device. In response to a selection of a particular selectable intellectual property data affordance, particular intellectual property data are retrieved from the database and provided to the client device.

### RELATED APPLICATION

This application is a continuation of, and claims benefit of, International Patent Application No. PCT/US24/58383, filed Dec. 4, 2024, titled “Web-Based Application For Managing Assets,” which claims benefit of U.S. Provisional Patent Application No. 63/605,963, filed Dec. 4, 2023, titled “Web-Based Application For Managing Assets,” which is incorporated by reference in its entirety.

### TECHNICAL FIELD

The present invention generally relates to the field of intellectual property portfolio management and, more particularly, to systems and methods for automating collection, tracking, organizing, optimization, and presentation relating to intellectual property management activities.

### BACKGROUND

Proper intellectual property management and tracking allows individuals and businesses to better protect their intellectual property. Data associated with intellectual property portfolios is often organized in extensive spreadsheets and data tables. Therefore there exists a need for a program designed to visualize, organize, and simplify intellectual property data. The combination of functionality, user interaction, and exporting options affords intellectual property owners better management of their intellectual properties and increased understanding of the greater intellectual property landscape. The intellectual property landscape may include product types being protected by intellectual property, jurisdictions, intellectual property owners, and so forth. A program as described herewith allows a user to better navigate data layers that otherwise tend to be cumbersome and unmanageable.

### SUMMARY

Various embodiments of this application are directed to managing intellectual property information, e.g., collection, tracking, organizing, optimization, and presentation relating to intellectual property items (e.g., patents and patent applications, trademarks). For instance, a computer system executes an intellectual property management application for managing intellectual property information regarding demographics, ownership, and enforcement of a plurality of intellectual property items of one or more organizations. The computer system causes a user interface of the intellectual property management application to be displayed on a client device associated with a user. In some embodiments, the intellectual property management application is a dedicated user application loaded and executed to enable the user interface on the client device. Alternatively, in some embodiments, the intellectual property management application is executed (e.g., via an application programming interface (API)) and displays its user interface via a web browser application. Demographic and enforcement information of the plurality of intellectual property items may be provided by different data sources in different data formats. For example, demographic information of the intellectual property items is imported from a spreadsheet created by a law firm, and the enforcement information is extracted from agreement documents, e.g., using machine learning. Intellectual property information of different data formats is consolidated in an intellectual property portfolio database, and visualized on the user interface of the intellectual property management application.

In some embodiments, the intellectual property information consolidated in the intellectual property portfolio database is visualized on the user interface of the intellectual property management application in response to a user query. Based on the user query, the computer system selects a first set of intellectual property items among the plurality of intellectual property items and determines a subset of demographic information types and a subset of enforcement information types. A set of information items of the first set of intellectual property items are identified based on the subset of demographic information types and the subset of enforcement information types. The computer system causes a client device to display an intellectual property information region and a map region concurrently on the user interface. The intellectual property information region includes the set of information items of the first set of intellectual property items, and the map region includes an interactive geographical map (also called an interactive data visualization) showing a plurality of jurisdictions. One or more jurisdictions are visually highlighted on the interactive geographical map based on the set of information items of the first set of intellectual property items.

Some implementations of this application are directed to a method for managing and visually displaying intellectual property portfolio data to a user. The method is implemented at a computer system in communication with an intellectual property portfolio database and a client device (e.g., via an application programming interface (API)). The method includes hosting an intellectual property management application including a user interface, receiving a request from a client device for the user interface, and in response to the request received from the client device, causing the client device to display the user interface. The user interface includes an interactive geographical map displaying independently selectable jurisdictions and selectable data affordances each of which is associated with a respective intellectual property item. The method further includes, in response to a first user selection of a first jurisdiction on the interactive geographical map, retrieving information of a first set of intellectual property items associated with the first jurisdiction from the intellectual property portfolio database, and providing the information of the first intellectual property items associated with the first jurisdiction to the client device. The method further includes, in response to a second user selection of a first selectable data affordance, retrieving information of a first intellectual property item from the intellectual property portfolio database, and providing the information of the first intellectual property item to the client device.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of managing and visually displaying intellectual property portfolio data to a user. The method also includes at a management server in communication with a database and a client device (e.g., via an API); hosting an intellectual property-data web application including one or more intellectual property-specific user interfaces receiving a request from a client device for an intellectual property information user interface; in response to receiving the request from the client device for the intellectual property information user interface, providing the intellectual property information user interface to the client device, the intellectual property information user interface including: an interactive data visualization, the interactive data visualization including independently selectable jurisdictions, and selectable intellectual property data affordances, each selectable intellectual property-data affordance being associated with a particular intellectual property data; in response to a user selection of a particular independently selectable jurisdiction on the interactive data visualization, retrieving particular intellectual property data from the database and providing the particular intellectual property data associated with the particular jurisdiction to the client device, and in response to a selection of a particular selectable intellectual property-data affordance, retrieving particular intellectual property data from the database and providing particular intellectual property data associated with the particular intellectual property to the client device. Other embodiments of this aspect include corresponding computer systems, apparatus, and computer programs recorded on one or more computer storage devices, each configured to perform the actions of the methods.

Implementations may include one or more of the following features. The system where displaying the particular intellectual property data associated with the particular jurisdiction includes displaying an overlay window including the particular intellectual property data. Displaying the particular intellectual property data associated with the particular jurisdiction includes providing a particular intellectual property data user interface including the particular intellectual property data. Displaying the particular intellectual property data associated with the particular jurisdiction includes displaying an overlay window including the particular intellectual property data in response to a first user action indicative of the user selection, and where displaying the particular intellectual property data associated with the particular jurisdiction includes providing a particular intellectual property data user interface including the particular intellectual property data in response to a second user action indicative of the user selection, where the section user action is separate and distinct from the first user action. The particular intellectual property data associated with the particular jurisdiction provided to the client device in response to a selection of a particular selectable jurisdiction includes at least one of: trademark name, trademark image, trademark application number, trademark registration number, trademark registration status, trademark filing date, trademark class, product type, and trademark licensing information. The particular intellectual property data associated with the particular intellectual property data provided to the client device in response to a selection of a particular selectable intellectual property data affordance includes at least one of: trademark name, trademark image, trademark application number, trademark registration number, trademark registration status, trademark filing date, trademark class, product type, and trademark licensing information. The management system is further configured to perform the steps of: providing an intellectual property data search interface configured to allow a user to request particular intellectual property information, the intellectual property data search interface including a search bar and selectable intellectual property data criteria including entity, trademark name and location; and in response to a user input provided in the search bar and a user selection of one of the intellectual property data criteria, providing a particular intellectual property information user interface specific to the user input and user selection. Implementations of the described techniques may include hardware, a method or process, or computer software on a computer-accessible medium.

Some implementations of this application include a computer system that includes one or more processors and memory having instructions stored thereon, which when executed by the one or more processors cause the one or more processors to perform any of the above methods for managing intellectual property information.

Some implementations include a non-transitory computer readable storage medium storing one or more programs. The one or more programs include instructions, which when executed by one or more processors cause the processors to implement any of the above methods for managing intellectual property information.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

The foregoing summary, as well as the following detailed description of embodiments of the system and method for virtual-assistant-enhanced access of private information, will be better understood when read in conjunction with the appended drawings of an exemplary embodiment. It should be understood, however, that the invention is not limited to the precise arrangements and instrumentalities shown.

FIG. 1 is a block diagram illustrating an implementation of a system for intellectual property portfolio management, in accordance with some embodiments;

FIGS. 2A-2P illustrate exemplary user interfaces generated by the management server associated with a method of viewing, managing, and/or downloading intellectual property portfolio information, in accordance with some embodiments;

FIG. 2Q is an example list 200 of element indexes for a plurality of elements applied in user interfaces 118 shown in FIGS. 2A-2P, in accordance with some embodiments;

FIG. 3 illustrates exemplary user interfaces generated by the management server associated with a method of viewing, managing, and/or downloading intellectual property portfolio information, in accordance with some embodiments;

FIG. 4 is an example flow diagram of an example process for managing intellectual property portfolio data of a plurality of data items, in accordance with some embodiments;

FIG. 5A is a block diagram of an example management server for managing intellectual property portfolio data for a plurality of organizations, in accordance with some embodiments;

FIG. 5B is a block diagram of an example client device for interacting with a user to receive user queries and present intellectual property portfolio data, in accordance with some embodiments;

FIG. 5C is a block diagram of an example data structure of intellectual property portfolio data stored in an intellectual property portfolio database, in accordance with some embodiments; and

FIGS. 6A and 6B is a flow diagram of an example method for managing intellectual property portfolio data of a plurality of intellectual property items of an organization, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

One general aspect of this application includes a method of managing and visually displaying intellectual property portfolio data to a user. The method also includes at a management server in communication with a database and a client device (e.g., via an API); hosting an intellectual property-data web application including one or more intellectual property-specific user interfaces receiving a request from a client device for an intellectual property information user interface; in response to receiving the request from the client device for the intellectual property information user interface, providing the intellectual property information user interface to the client device, the intellectual property information user interface including: an interactive data visualization, the interactive data visualization including independently selectable jurisdictions, and selectable intellectual property data affordances, each selectable intellectual property-data affordance being associated with a particular intellectual property data; in response to a user selection of a particular independently selectable jurisdiction on the interactive data visualization, retrieving particular intellectual property data from the database and providing the particular intellectual property data associated with the particular jurisdiction to the client device, and in response to a selection of a particular selectable intellectual property-data affordance, retrieving particular intellectual property data from the database and providing particular intellectual property data associated with the particular intellectual property to the client device. Other embodiments of this aspect include corresponding computer systems, apparatus, and computer programs recorded on one or more computer storage devices, each configured to perform the actions of the methods.

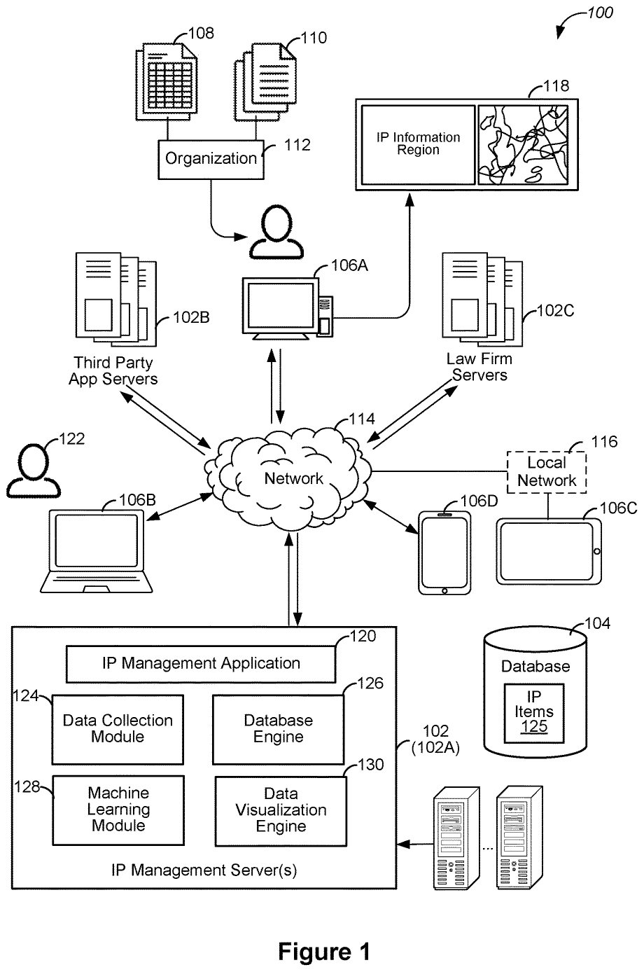

FIG. 1 is a block diagram illustrating an implementation of a system 100 for intellectual property portfolio management, generally designated 100 and referred to as system 100. While some example features are illustrated, various other features have not been illustrated for the sake of brevity and so as not to obscure pertinent aspects of the example embodiments disclosed herein. To that end, as a non-limiting example, the system for intellectual property portfolio management, referred to herein as system 100, may include one or more computing devices in communication with one or more networked servers. The one or more networked servers may share any number of logical units.

In some embodiments, the system 100 includes a management server 102, one or more client devices 106, and one or more databases 104. The management server 102 may be one or more computing servers that provide secure access to intellectual property jurisdiction information, intellectual property ownership information, intellectual property enforcement information, and/or intellectual property demographic information which may be stored on database 104. The management server 102 (e.g., a server 102A) may execute an intellectual property management application 120 having a plurality of user accounts associated with a plurality of users 122. The management server 102 further includes one or more of a data collection module 124 for collecting data associated with a plurality of intellectual property items 125 and having different data formats, a data processing module 126 for processing data associated with the plurality of intellectual property items 125 (e.g., converting a data format, consolidating data from different sources), a machine learning module 128 for training and applying machine learning models, and a data visualization engine 130 for presenting the data of the intellectual property items 125 on a user interface 118. In some embodiments, the management server 102 includes a third party application server 102B executing alternative intellectual property management programs (e.g., a web-based patent office application) and/or a law firm server 102C managing a private intellectual property database storing information of intellectual property items 125 owned by a law firm's clients.

Database 104 may have stored thereon data relating to intellectual property jurisdiction information, intellectual property owner information, intellectual property enforcement information, and/or intellectual property demographic information. The intellectual property portfolio information may include but is not limited to: the intellectual property name; the intellectual property owner; the intellectual property jurisdictions; the intellectual property status; and the intellectual property restrictions. The management server 102 and database 104 may be in communication, such that intellectual property portfolio information including but not limited to intellectual property jurisdiction information, intellectual property owner information, intellectual property enforcement information, and/or intellectual property demographic information may be transmitted between the server 102 and database 104. Intellectual property portfolio information may be sourced from CPI report data or functionally equivalent structured intellectual property data (e.g., first file 108). The CPI program allows users to manage intellectual property portfolios and the associated data. In some embodiments, the management server 102 may be configured to transmit to a client device 106 an administrator-facing user interface that allows users (e.g., administrators) to input intellectual property portfolio-specific information including but not limited to intellectual property jurisdiction information, intellectual property owner information, intellectual property enforcement information, and/or intellectual property demographic information. In some embodiments, an information item (e.g., a licensee name) may correspond to both demographic information and enforcement information of an intellectual property item (e.g., a trademark).

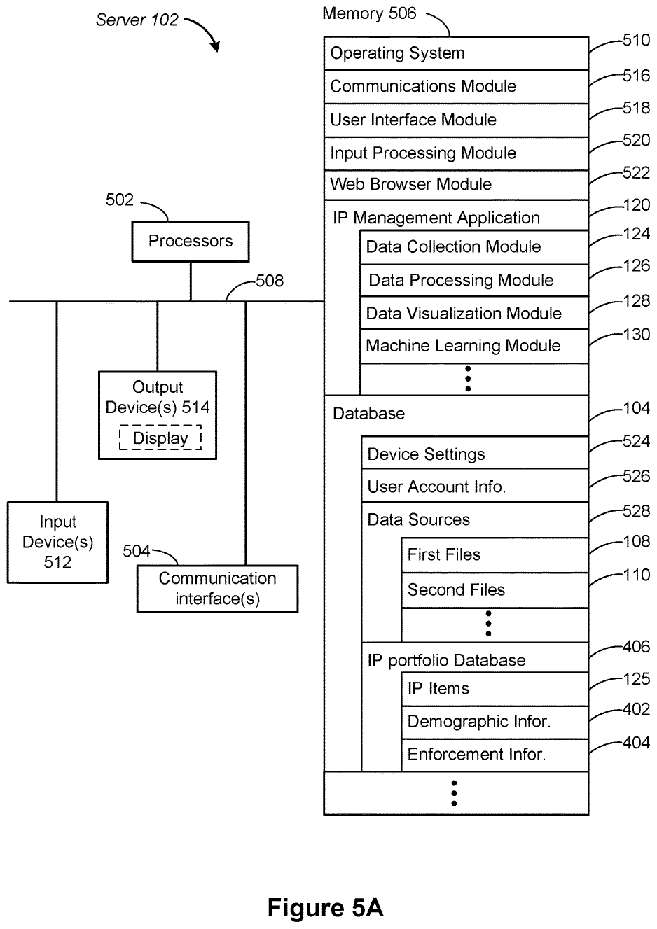

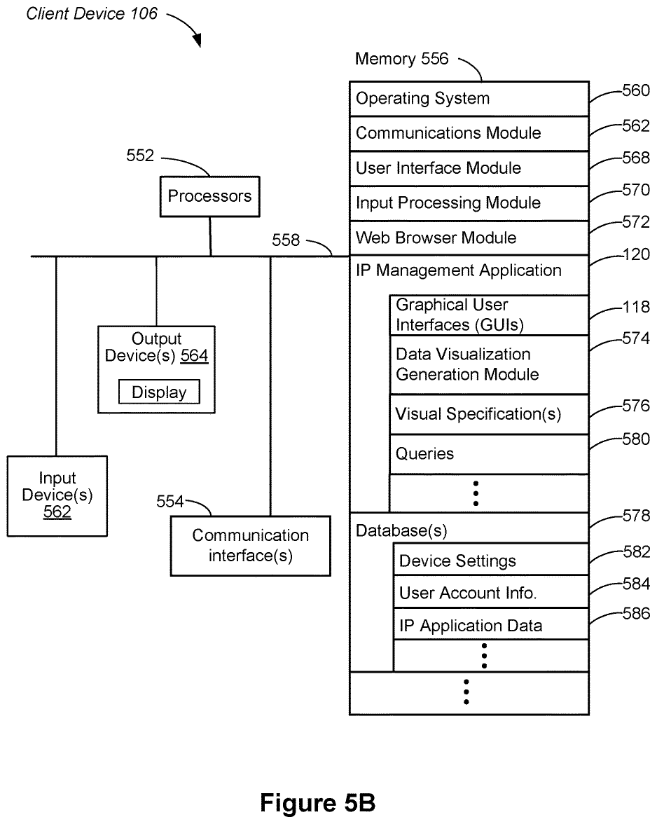

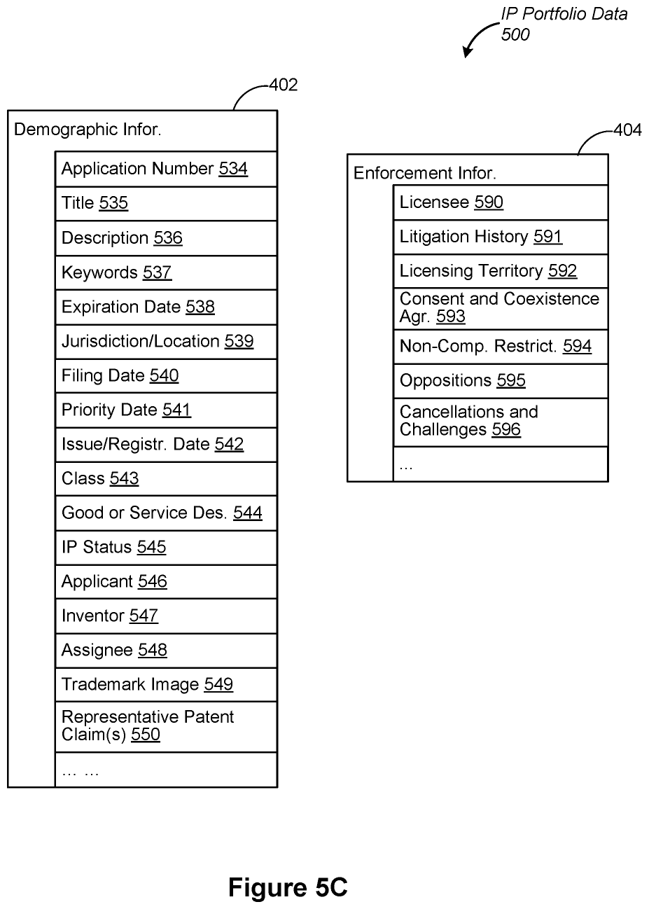

In some embodiments, the intellectual property enforcement information may be extracted from a plurality of second files 110 associated with a plurality of intellectual property items 125 (e.g., registered trademarks, trademark applications, patent applications, patents), and each second file 110 has a natural language format. For example, each second file 110 is one of a technology transfer agreement, an intellectual property licensing agreement, a business contract including an intellectual property right section, and a legal document including laws related to intellectual property enforcement. The plurality of second files 110 are processed (e.g., using machine learning techniques) to extract the enforcement information of the plurality of intellectual property items 125 based on a plurality of enforcement information types (e.g., licensee, licensing territory, non-compete restrictions, legal actions, licensing duration). By these means, in some embodiments, the demographic information and the enforcement information of the plurality of intellectual property items 125 are extracted from different data sources (e.g., first files 108, second files 110) and consolidated in a database 104 according to a common data format associated with the database 104. In an example, each row of the databased 104 corresponds to a respective intellectual property item, and each column corresponds to a respective type of the demographic information and the enforcement information. More details on a data structure of the database 104 consolidating information of intellectual property items 125 are discussed below with reference to FIG. 5C.

In some embodiments, information and/or data input at the administrator-facing user interface may be transmitted to the database 104 for storage. Administrators may be users that have permission to edit, upload, or remove intellectual property portfolio information at the management server. In some embodiments, the management server 102 may be configured to transmit to a client device 106 a non-administrator-facing user interface that allows users (e.g., non-administrators) to search intellectual property portfolio data, view information relating to the intellectual property portfolio, and/or download data pertaining to the intellectual property.

In some embodiments, information and/or data input at the non-administrator-facing user interface may be transmitted to the database 104 for storage. Non-administrators may refer to intellectual property owners or any other entity that does not have permission to edit, upload, or remove intellectual property portfolio information at the management server.

The one or more client devices 106 may be, for example, desktop computers 106A, laptop computers 106B, tablet computers 106C, mobile phones 106D, or any other computing devices. Each client device 106 can collect data or user inputs, executes a client-side intellectual property management application, and present outputs on its user interface 118. The collected data or user inputs can be processed locally at the client device 106 and/or remotely by the server(s) 102. The management server 102 provides system data (e.g., boot files, operating system images, and user applications) to the client devices 106, and in some embodiments, processes the data and user inputs received from the client device(s) 106 when the intellectual property management applications are executed on the client devices 106. In some embodiments, the database 104 stores data related to the management server 102, client devices 106, and applications executed on the client devices 106. In some embodiments, the database 104 includes one or more databases for storing the data in an organized manner, where data received from different sources and having different data formats may be converted to a common data format and stored in the database 104.

The management server 102 is configured to enable real-time data communication with the client devices 106 that are remote from each other or from the management server 102. Further, in some embodiments, the management server 102 are configured to implement data processing tasks that cannot be or are preferably not completed locally by the client devices 106. For example, the client devices 106 include a laptop computer 106B that executes an intellectual property management application for tracking and visualizing information of a plurality of intellectual property items 125 associated with a respective organization 112. The management server 102 collects demographic data and enforcement data from one or more data sources (e.g., files 108 and 110). The demographic data and enforcement data are consolidated, processed, and visualized interactively. For example, such data are matched with other data, categorized, or applied to synthesize related data, e.g., based on jurisdictions or territories related to the plurality of intellectual property items 125. In some embodiments, data of the intellectual property items 125 are provided by multiple data sources, have unclear or weak correlations, and include natural language data collected from individual agreements in a subjective and descriptive format. The management server 102 may include a plurality of management servers 102 configured to create an information management platform to collect, process, manage, and visualize a large volume of complex intellectual property data, which cannot be accomplished by human.

The management server 102 (e.g., servers 102A-102C), one or more client devices 106 (e.g., devices 106A-106D), and databases 104 are communicatively coupled to each other via one or more communication networks 114, which are the medium used to provide communications links between these devices and computers connected together within the system 100. The one or more communication networks 114 may include connections, such as wire, wireless communication links, or fiber optic cables. Examples of the one or more communication networks 114 include local area networks (LAN), wide area networks (WAN) such as the Internet, or a combination thereof. The one or more communication networks 114 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 114 may be established either directly (e.g., using 3G/4G connectivity to a wireless carrier), or through a network interface 116 (e.g., a router, switch, gateway, hub, or an intelligent, dedicated whole-home control node), or through any combination thereof. As such, the one or more communication networks 114 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, machine learning techniques are applied by an intellectual property management application 120 to collect, process, and visualize data associated with a plurality of intellectual property items 125 (e.g., registered trademarks, trademark applications, patent applications, patents). In some embodiments, in these machine learning techniques, machine learning models (e.g., large language model, information extraction model, natural language processing model) are created based on one or more neural networks to process the data associated with the intellectual property items 125. A machine learning model is trained with training data (e.g., existing agreements) before they are applied to process the data associated with the intellectual property items 125 for data inference. Further, in some embodiments, the machine learning model is further trained using the data associated with the intellectual property items 125. Particularly, in some embodiments, machine learning is applied to extract complicated information items associated with enforcement information from legal documents automatically and visualize such information items in a user friendly manner, which expands a computer system's capabilities to analysis of complex and abstract legal information that can only be accomplished by humans.

In some embodiments, both model training and data inference are implemented locally at each individual client device 106. The client device 106 obtains the training data from the management server 102 or database 104, applies the training data to train the machine learning models, and uses the learning models to process current data. Alternatively, in some embodiments, data inference is implemented locally at a client device 106, while model training is implemented remotely at a server 102 associated with the client device 106. The server obtains the training data from itself, another server 102 or the database 104 and applies the training data to train the machine learning models. The trained machine learning models are optionally stored in the server 102 or database 104. The client device 106 imports the trained machine learning models from the server 102B or database 104, processes the data of the intellectual property items 125 using the machine learning models, and generates data processing results (e.g., restrictions of a client's intellectual property license agreement) to be presented on a user interface 118.

Alternatively, in some embodiments, both model training and data inference are implemented remotely at a server 102 (e.g., the server 102A) associated with a client device 106, particularly if a large volume of complex data are involved. The server 102A obtains the training data from itself, another server 102 or the database 104 and applies the training data to train the machine learning models. The client device 106 receives data processing results from the server 102 and presents the results on a user interface 118 of the intellectual property management application 120. The client device 106 itself implements no or little data processing on the data processing results. In some embodiments, the client device 106 enters an input (e.g., a user query) to define one or more parameters (e.g., a registration location, an owner, a name, or a keyword of a trademark) for data inference, and the server 102 generates the data processing results based on the input. Additionally, in some embodiments, a client-side intellectual property management application 120 collaborates with a server-side intellectual property management application 120 to deliver the data processing results. The client-side intellectual property management application 120 presents a user interface 118 where the input from a user is received and data processing results are presented. The server-side intellectual property management application 120 collects and processes data (e.g., using the machine learning techniques), and enables display of the user interface 118. An example of the data processing results includes demographic information of trademarks owned by a user and detailed enforcement restrictions extracted from a plurality of agreements of the trademarks.

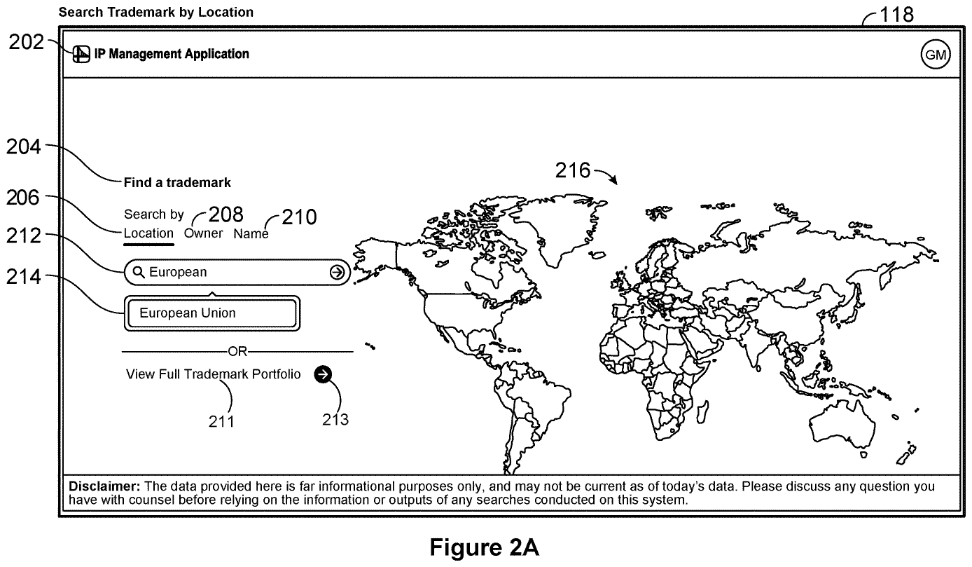

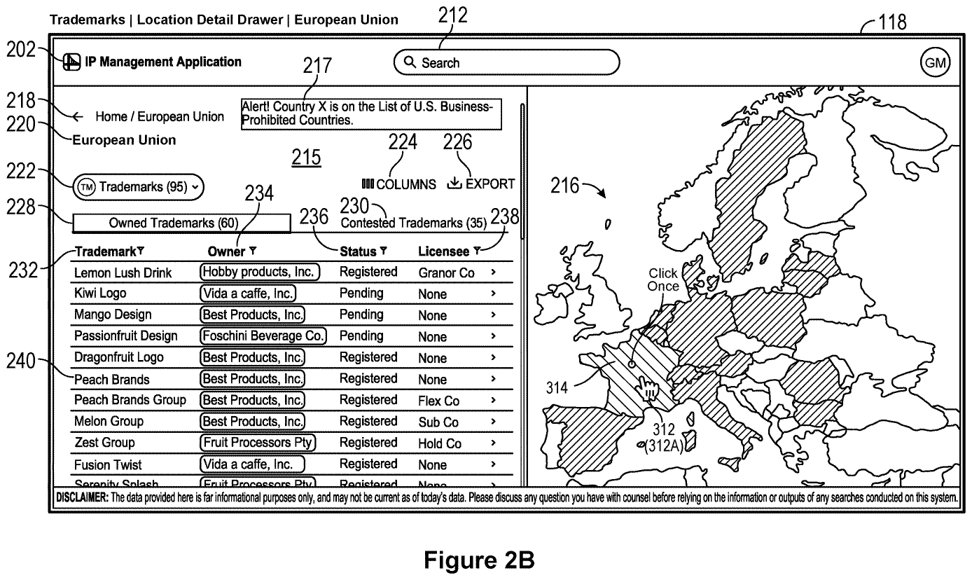

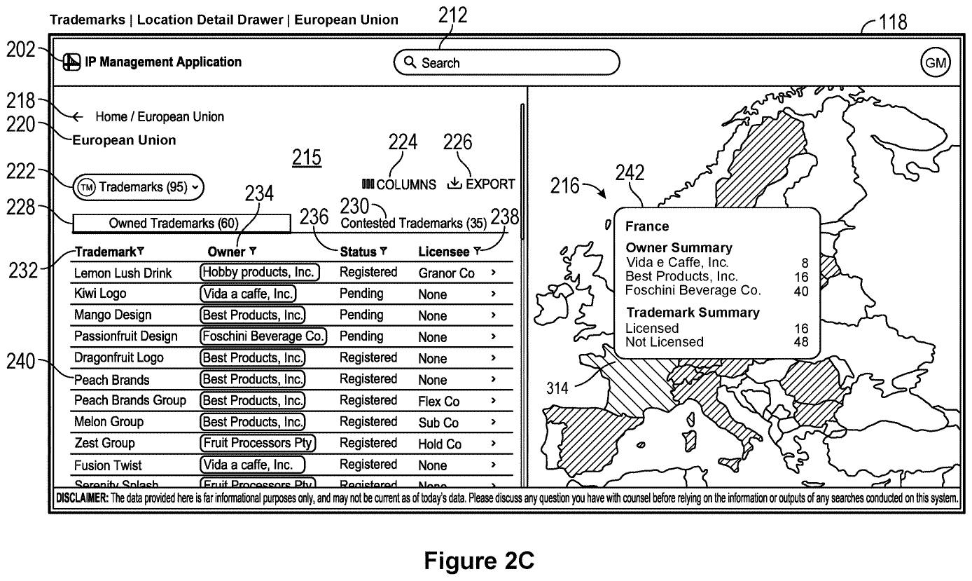

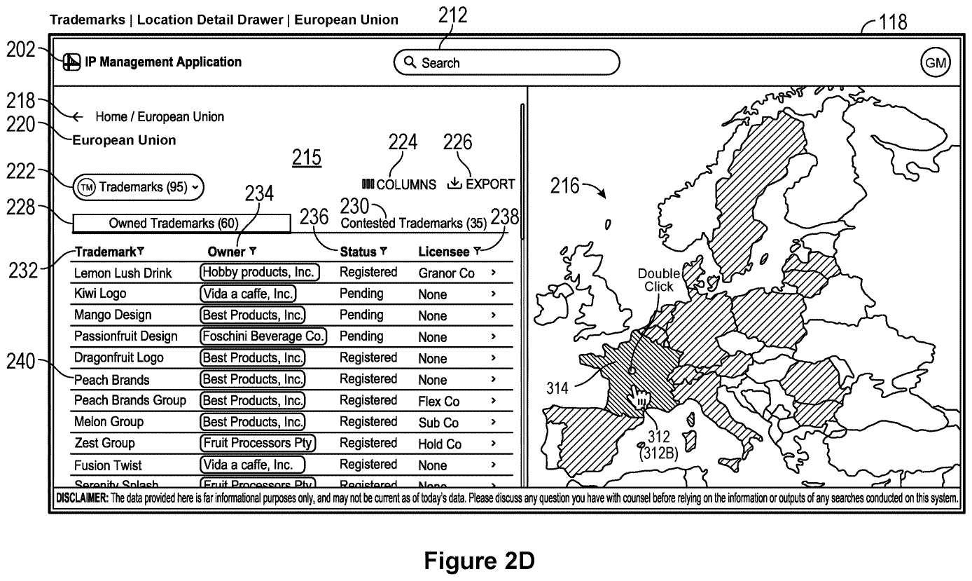

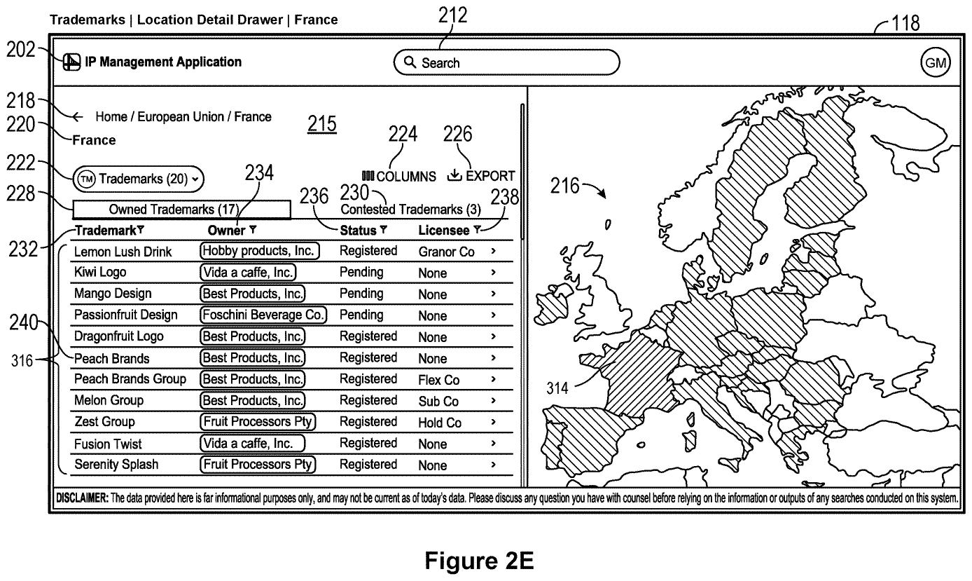

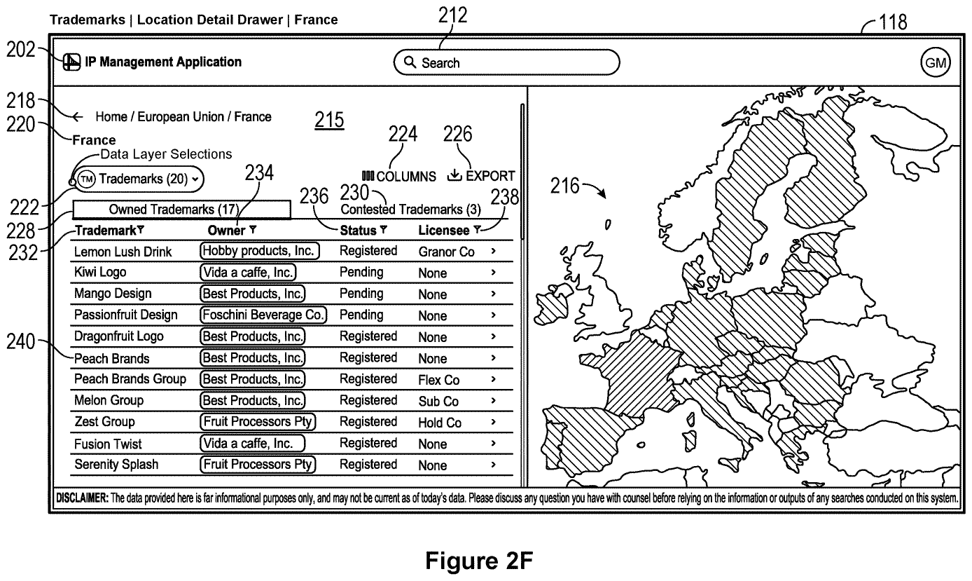

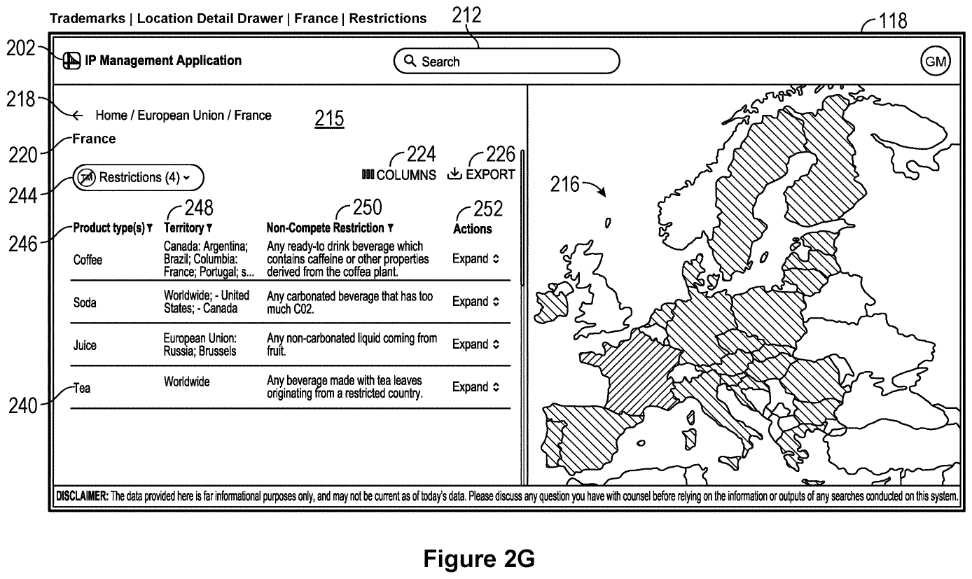

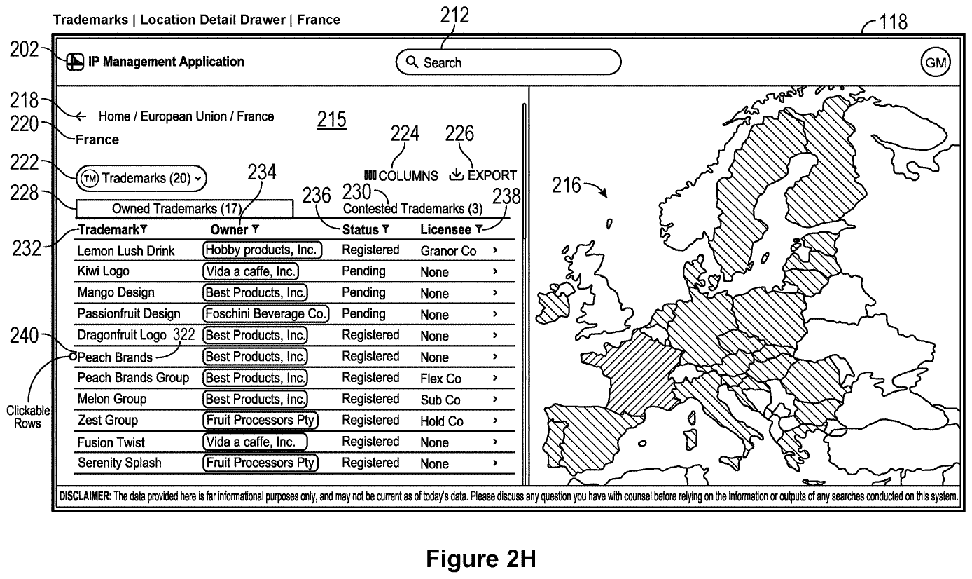

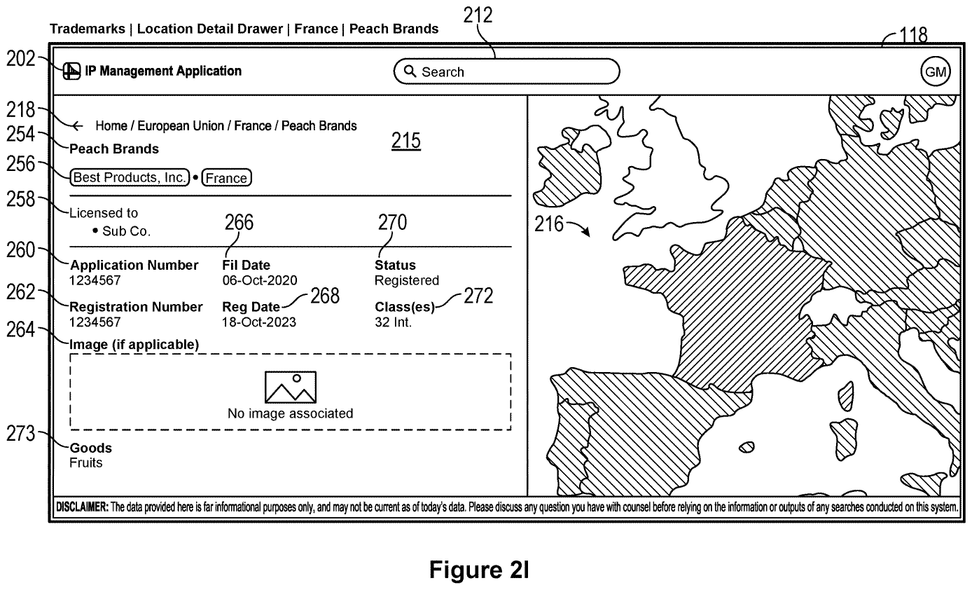

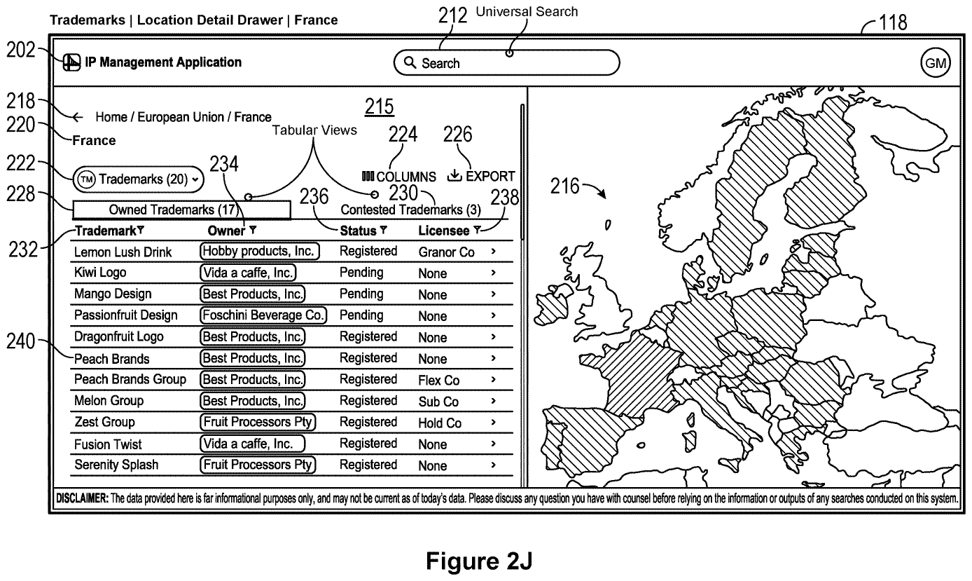

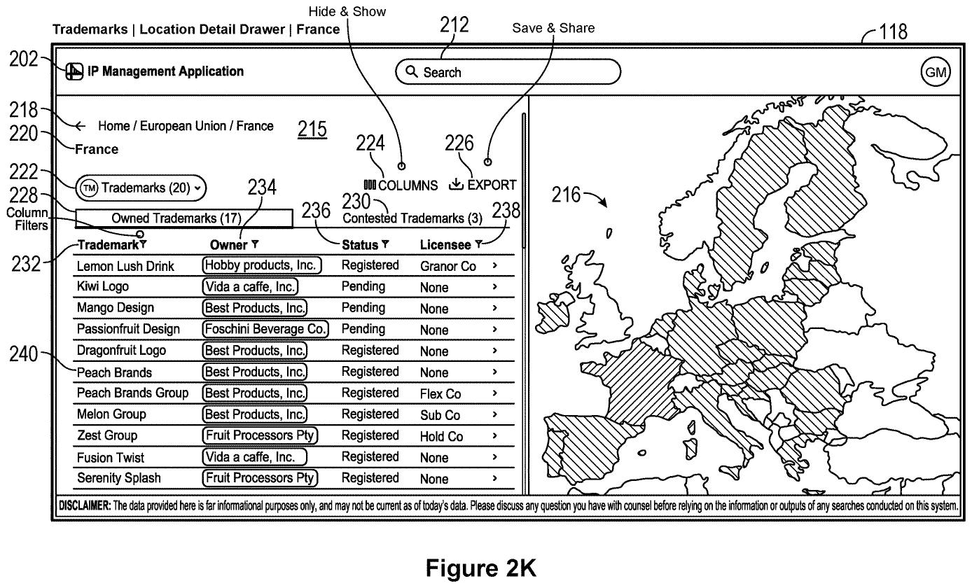

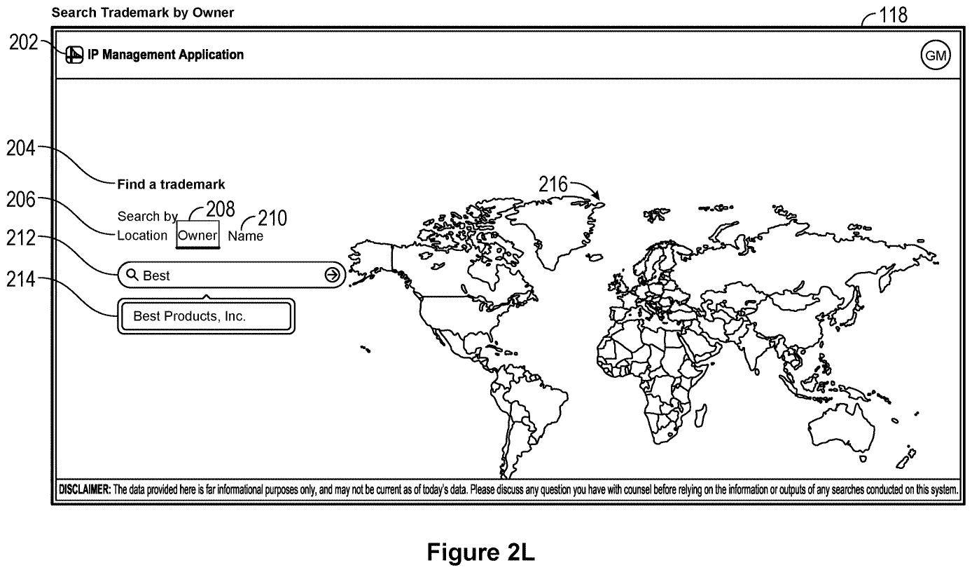

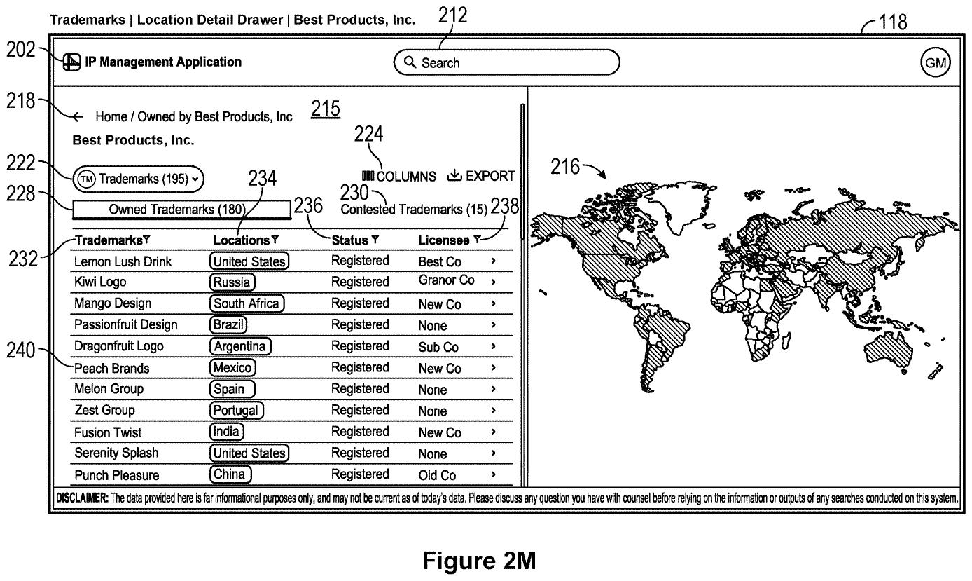

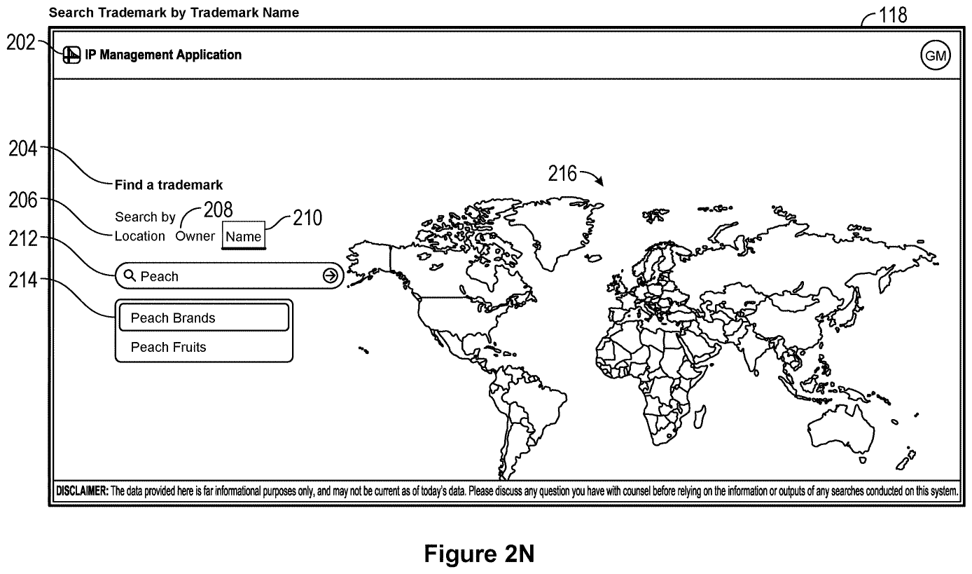

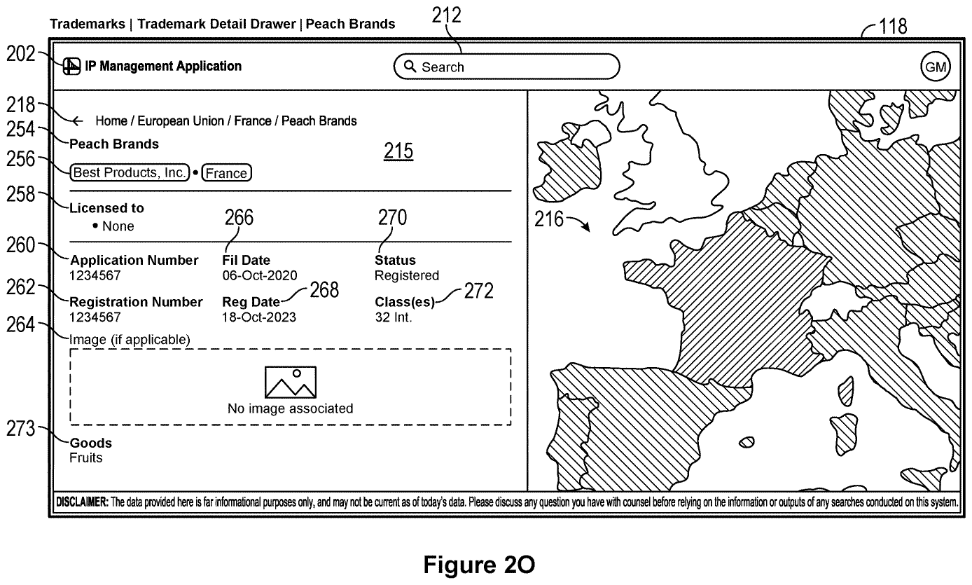

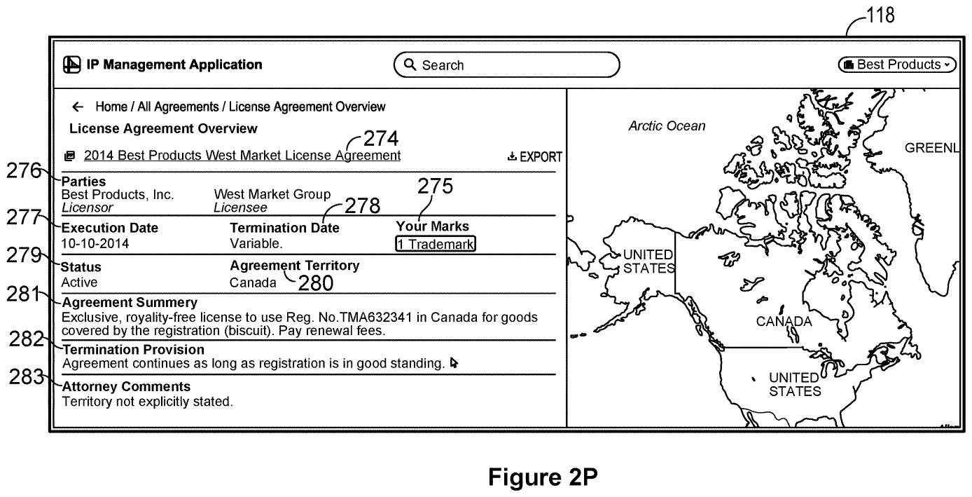

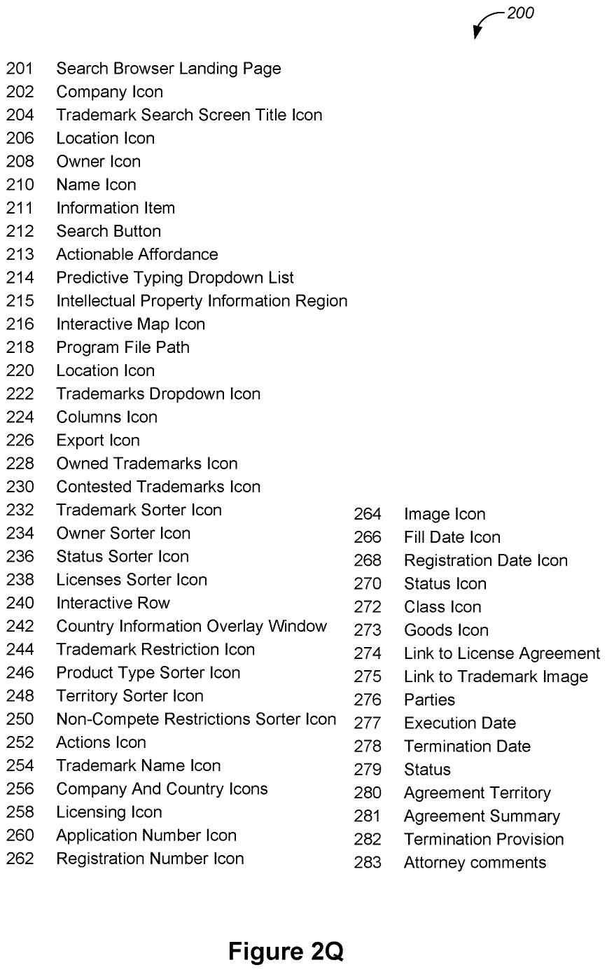

Each of the user interfaces 118 generated by the management server 102 for accessing intellectual property information of a plurality of intellectual property items (e.g., trademark is discussed in further detail with reference to FIGS. 2A-2P. FIG. 2Q is an example list 200 of element indexes for a plurality of elements applied in user interfaces 118 shown in FIGS. 2A-2P, in accordance with some embodiments.

FIG. 2A depicts an example user interface 118 for a landing page for an intellectual property search browser, generally designated 202, in accordance with some embodiments. In some embodiments, the intellectual property search browser 202 corresponds to an intellectual property management application 120, which is a dedicated application. Alternatively, in some embodiments, the intellectual property search browser 202 corresponds to an intellectual property management application 120, which is loaded (e.g., via an API) within a web browser. The user interface 118 may include an intellectual property search tool bar 212. The intellectual property search tool bar 212 receives user-inputted criteria. The intellectual property search tool bar may allow a user to search for an entity's intellectual properties in a more user-friendly format. The criteria may be in the form of a location 206. Location 206 may refer to the location of intellectual properties that may be owned by an individual, an entity, a corporation, or a business. The criteria may be in the form of an intellectual property owner. A intellectual property owner may include an individual, a corporation, or a business. The criteria may include an intellectual property name. A intellectual property name may define the descriptive word or phrase used to identify a specific intellectual property. An example of an intellectual property name may be “Peach Brands” found in FIG. 2°. The user interface 118 is equipped with a predictive-typing drop-down window 214. For illustration purposes in FIG. 2A, the user-inputted criteria is “European.” In this example, the predictive typing results display “European Union.” Once the user inputs the search criteria into the intellectual property search tool bar 212, the user may be directed to a criteria-specific landing page as depicted in FIG. 2B.

In some embodiments, the user interface 118 displays an information item 211 and an actionable affordance 213 for viewing a full trademark portfolio of one or more organizations to which a user account has access. In response to a user selection of the actionable affordance 213 on the user interface 118, a landing page is loaded to display the full trademark portfolio without applying any filters or search criteria.

FIG. 2B illustrates an example landing page for the results of the user-inputted criteria in FIG. 2A, in accordance with some embodiments. This landing page depicts intellectual property information for the “European Union” input 220. The intellectual property information may include owned intellectual properties 228. Owned intellectual properties refer to a registered intellectual property that may be owned by an individual, entity, a corporation, or business. The intellectual property information may include contested intellectual properties 230. Contested intellectual properties may refer to a registered patent that is less than five years old that enables a prior user to continue using the intellectual property within two conditions: (1) the intellectual property was used prior to registrant's filing date and (2) in accordance with common law rights. The intellectual property data may be sourced from CPI report data or functionally equivalent structured intellectual property data. The CPI program allows users to manage intellectual property portfolios and the associated data. Featured on this landing page is an intellectual properties button 222. The intellectual properties button may be configured to when clicked open a drop-down window displaying a restrictions and agreements view option. The user interface 118 features a columns button 224. The columns button may be configured to when clicked expand on intellectual property-specific data. The user interface 118 features an export button 226. The export button 226 may be configured to when clicked enable a user to export and download the intellectual property data. Also illustrated in this figure is an interactive data visualization 216 (e.g., an interactive geographical map 216 including a plurality of jurisdiction). The illustrative data visualization may be configured to be clicked by a user such as a user can “single click” on a jurisdiction and view more detailed information based on the location selection. The landing page also displays an intellectual property sorter button 232. The intellectual property sorter button may be configured to when clicked rearrange the displayed rows based on the user's sort preference. The landing page may feature an owner sorter button 234. The owner sorter button may be configured to when clicked arrange the rows based upon the owner of the intellectual property. The landing page also displays a licenses sorter button 238. The licenses sorter button 238 may be configured when clicked to arrange the rows based on the licenser of the displayed intellectual property. The landing page also displays a status sorter button 236. The status sorter button 336 may be configured to when clicked sort the intellectual property rows based on the status of the intellectual properties. The status of the intellectual properties may include but is not limited to “registered” or “pending.” The landing page features a search browser tool bar 212. The search browser tool bar may be configured to accept user-inputted criteria. This search browser tool bar may allow the user to perform a new search without leaving the current landing page.

In some embodiments, the landing page shown in FIG. 2B may display a banner 217 or a notice including the information identifying one or more U.S. business-prohibited countries. The one or more U.S. business-prohibited countries may be visually highlighted on the interactive data visualization 216. For example, a prohibited country is highlighted with a thicker borderline or a unique fill pattern. In some embodiments, the banner 217 may display information related to a state-level record.

FIG. 2C illustrates the data returned once a user “single clicks” on one of the jurisdictions in the interactive data visualization 216 as shown in FIG. 2B, in accordance with some embodiments. The interactive data visualization may be configured to when clicked display an overlay window 242 over the data visualization. The overlay window 242 may be configured to include owner and intellectual property data for the clicked-on jurisdiction. In the figure example, the user has “single clicked” on France, prompting the user interface 118 to display an overlay window. The example overlay window includes an owner summary and an intellectual properties summary for France. The user can then either “single click” on an unhighlighted location to remove the overlay window or “double click” on the already highlighted jurisdiction to see a jurisdiction-specific landing page.

Alternatively, in some embodiments not shown, the user moves a cursor onto one of the jurisdictions, and hold the cursor on the one of the jurisdictions for a predefined time duration to trigger display of the overlay window 242.

FIG. 2D illustrates the data returned when a user “single clicks” on an unhighlighted location to remove the overlay window as depicted in FIG. 2C, in accordance with some embodiments. The landing page may depict intellectual property information for the “European Union” input 220. The landing page features owned intellectual properties 228. The landing page features contested intellectual properties 230. The intellectual property data is sourced from CPI report data or functionally equivalent structured intellectual property data. Featured on this landing page is an intellectual properties button 222, which when clicked opens a drop-down window displaying, but not limited to, a restrictions and agreements view option. The user interface 118 features a columns button 224 to expand on intellectual property-specific data. The user interface 118 features an export 226 button enabling a user to export and download the intellectual property data. Also illustrated in this figure is an interactive data visualization 216 in which a user can “single click” on a jurisdiction and view more detailed information based on their location selection. The landing page may display an intellectual property sorter button 232, an owner sorter button 234, a status sorter button 236, and/or a licenses sorter button 238. Located at the top of the landing page is a search browser tool bar 212 in which a user can input new search criteria without leaving the current landing page.

FIG. 2E illustrates an example landing page for the results of a user “double clicking” on a jurisdiction as shown in FIG. 2B, in accordance with some embodiments. In this example, the landing page features intellectual property-specific information for France 220. Featured on this landing page is an intellectual properties button 222. The landing page displays intellectual property information in terms of owned intellectual properties 232. The landing page displays intellectual property information for contested intellectual properties 230. The user interface 118 features a columns button 224. The user interface 118 features an export button 226. Also illustrated in this figure is an interactive data visualization 216.

FIG. 2F depicts an example continuation of FIG. 2E, a landing page for the results of a user “double clicking” on a jurisdiction, in accordance with some embodiments. In this example the landing page is for France 220. Highlighted in this figure is the intellectual properties button 222.

FIG. 2G illustrates the landing page for the results of selecting “restrictions” from the drop-down selection of the intellectual properties button 244, in accordance with some embodiments. The landing page displays the product-type sorter button 246. The product type may include but is not limited to a food or beverage product. When clicked, the product-type sorter button may sort the rows according to their product category. The landing page displays a territory sorter button 248. The territory sorter button may when clicked sort the rows according to their territory. A territory may include a country or an international alliance of several jurisdictions. In this example, territories shown include the European Union, Albania, Belarus, Worldwide, and Romania. The landing page features a noncompete restrictions sorter button 250. The noncompete restrictions sorter button may be configured to when clicked sort the rows according to the restrictions imposed on that product type in its specific territories. The landing page features an actions button 252. The actions button 252 may be configured to when clicked allow the user to expand an intellectual property row or collapse an intellectual property row. The landing page features a columns button 224. The user interface 118 features an export button 226.

In some embodiments, the intellectual properties buttons 222 and 244 correspond to a drop-down menu, allowing the web-based application to offer a multi-layer view. For example, the drop-down menu may include three options of “trademarks,” “agreements,” and “restrictions” corresponding to a trademark data layer view, an agreement data layer view, and a restriction data layer view. In some situations, the trademark data layer view may be focused on displaying demographic information, and the agreement data layer view and the restriction data layer view are focused on displaying enforcement information extracted from license agreements and intellectual property laws.

FIG. 2H depicts an example continuation of FIG. 2E of a landing page for the results of a user “double clicking” on a jurisdiction, in accordance with some embodiments. In this example the landing page is for France 220. Highlighted in this figure is the “clickable rows” 240. The clickable rows may be configured to when clicked direct the user to a new landing page. The resulting landing page in FIG. 2I illustrates intellectual property-specific data based on the user-selected row.

FIG. 2I displays an example landing page illustrating the results of selecting one of the table rows by clicking on a row, in accordance with some embodiments. Once the row is clicked, the intellectual property data may expand into a new landing page. In this figure, the user selected the intellectual property row for the “Peach Brands” 254 intellectual property. In the landing page, intellectual property-specific information may include licensing information 258. Licensing information 258 may include the individuals, entities, corporations, or businesses to which the intellectual property is licensed. The landing page also includes an application number 260. The application number 260 may be the numeric identifier associated with the registered intellectual property. The landing page also features a registration number 262. The registration number 262 may represent the numeric identifier associated with the registered intellectual property. The landing page also features images 264. The images 264 may be illustrative representations of the intellectual property. The landing page also features a filing date 266. The filing date 266 may be the date on which the intellectual property application was filed. The landing page also features a registration date 268. The landing page also features a status indicator 270. The status indicator 270 may identify the intellectual property as registered. The landing page also features a goods classification identifier 273. The goods classification identifier 273 may provide a categorical description for the intellectual property. In this example, the goods classification is “fruit juices.” The landing page also features a class identifier 272. The class identifier 272 may display the number of intellectual property classes covered by the selected intellectual property. Beneath the intellectual property name is the owner and location 256. In this example the owner is Best Products, Inc. and the location is France.

FIG. 2J depicts an example continuation of FIG. 2E, an example landing page for the results of a user “double clicking” on a jurisdiction, and in this example the landing page is for France. On this landing page, the tabular views options are highlighted. The tabular views may include owned intellectual properties button 228. The tabular views may also include contested intellectual properties button 230. On this landing page, the universal search tool bar 212 is highlighted. The universal search tool bar allows the user to initiate a new search without having to return to the FIG. 2A landing page.

FIG. 2K depicts an example continuation of FIG. 2E, a landing page for the results of a user “double clicking” on a jurisdiction, and in this example the landing page is for France 220. On the landing page, the columns button 224 is highlighted. On the landing page, the export button 226 is highlighted. On the landing page, the column filter buttons 232, 234, 236, and 238 are highlighted.

FIG. 2L depicts an example user interface 118 for a landing page for an intellectual property search browser, generally designated 202, in accordance with some embodiments. The user interface 118 may include an intellectual property search tool bar 212. The intellectual property search tool bar 212 receives user-inputted criteria. The criteria may be in the form of an intellectual property owner name 208. The user interface 118 is equipped with a predictive typing drop-down window 214. In FIG. 2L, the user-inputted criteria is “Best.” In this example, the predictive typing results display “Best Products, Inc.” Once the user inputs the search criteria into the intellectual property search browser, the user is directed to a criteria-specific landing page as depicted in FIG. 2M.

FIG. 2M illustrates an example landing page for the results of the user-inputted criteria in FIG. 2L, in accordance with some embodiments. This landing page depicts intellectual property information for the “Best” input 220. The intellectual property information may include owned intellectual properties 228. The intellectual property information may include contested intellectual properties 230. Featured on this landing page is an intellectual properties button 222. The intellectual properties button may be configured to when clicked open a drop-down window displaying, but not limited to, a restrictions and agreements view option. The user interface 118 features a columns button 224. The columns button may be configured to when clicked expand on intellectual property-specific data. The user interface 118 features an export 226 button. The export button may be configured to when clicked enable a user to export and download the intellectual property data. Also illustrated in this figure is an interactive data visualization 216. The illustrative data visualization may be configured to be clicked by a user; for example, a user can “single click” on a jurisdiction and view more detailed information based on the location selection. The landing page also displays an intellectual property sorter button 232. The intellectual property sorter button may be configured to when clicked rearrange the displayed rows based on the user's sort preference. The landing page also features an owner sorter button 234. The owner sorter button 234 may be configured to when clicked arrange the rows based on the owner of the intellectual property. The landing page also displays a licenses sorter button 238. The licenses sorter button 238 may be configured when clicked to arrange the rows based upon the licenser of the displayed intellectual property. The landing page also displays a status sorter button 336. The status sorter button 336 may be configured to when clicked sort the intellectual property rows based on the status of the intellectual properties. The status of the intellectual properties may include but is not limited to “registered” or “pending.” The landing page features a search browser tool bar 212. The search browser tool bar 212 may be configured to accept user-inputted criteria. This search browser tool bar may allow the user to perform a new search without leaving the current landing page.

FIG. 2N depicts an example user interface 118 for a landing page for an intellectual property search browser, generally designated 201, in accordance with some embodiments. The user interface 118 may include an intellectual property search tool bar 212. The intellectual property search tool bar 212 receives user-inputted criteria. The criteria may be in the form of an intellectual property name 208. The user interface 118 is equipped with a predictive typing drop-down window 214. In FIG. 2N, the user-inputted criteria is “Peach.” In this example, the predictive typing results display “Peach Brands” and “Peach Fruits.” Once the user inputs the search criteria into the intellectual property search browser, the user is directed to a criteria-specific landing page as depicted in FIG. 2O.

FIG. 2O illustrates an example landing page for the results of the user-inputted criteria in FIG. 2N, in accordance with some embodiments. This landing page depicts intellectual property information for the “Peach” input 220. The intellectual property information may include owned intellectual properties 228. The intellectual property information may include contested intellectual properties 230. The intellectual property data is sourced from CPI report data or functionally equivalent structured intellectual property data. Featured on this landing page is an intellectual properties button 222. The intellectual properties button may be configured to when clicked open a drop-down window displaying, but not limited to, a restrictions and agreements view option. The user interface 118 features a columns button 224. The columns button may be configured to when clicked expand on intellectual property-specific data. The user interface 118 features an export button 226. The export button 226 may be configured to when clicked enable a user to export and download the intellectual property data. Also illustrated in this figure is an interactive data visualization 216. The illustrative data visualization may be configured to be clicked by a user; for example, a user can “single click” on a jurisdiction and view more detailed information based on the location selection. The landing page also displays an intellectual property sorter button 232. The intellectual property sorter button 232 may be configured to when clicked rearrange the displayed rows based on the user's sort preference. The landing page also features an owner sorter button 234. The owner sorter button may be configured to when clicked arrange the rows based on the owner of the intellectual property. The landing page also displays a licenses sorter button 238. The licenses sorter button 238 may be configured when clicked to arrange the rows based on the licenser of the displayed intellectual property. The landing page also displays a status sorter button 336. The status sorter button 336 may be configured to when clicked sort the intellectual property rows based on the status of the intellectual properties. The status of the intellectual properties may include but is not limited to “registered” or “pending.” The landing page features a search browser tool bar 212. The search browser tool bar may be configured to accept user-inputted criteria. This search browser tool bar may allow the user to perform a new search without leaving the current landing page.

FIG. 2P displays an example landing page illustrating a license agreement overview, in accordance with some embodiments. In some embodiments now shown, an example landing page may illustrate the results of selecting a licensee name (e.g., “Sub Co”) listed under intellectual property licensing information 258 (if any, FIG. 2I) or in a licenses sorter button 238 (FIGS. 2B-2F). The landing page may feature a link 274 to a license agreement, a link to an image 275 of a trademark, and enforcement information covering parties 276, execution date 277, termination date 278, status 279, agreement territory 280, agreement summary 281, termination provision 282, and attorney comments 283. In some situations, upon receiving a user action on the link to the license agreement, the web-based application opens the license agreement (e.g., a PDF document) for further review.

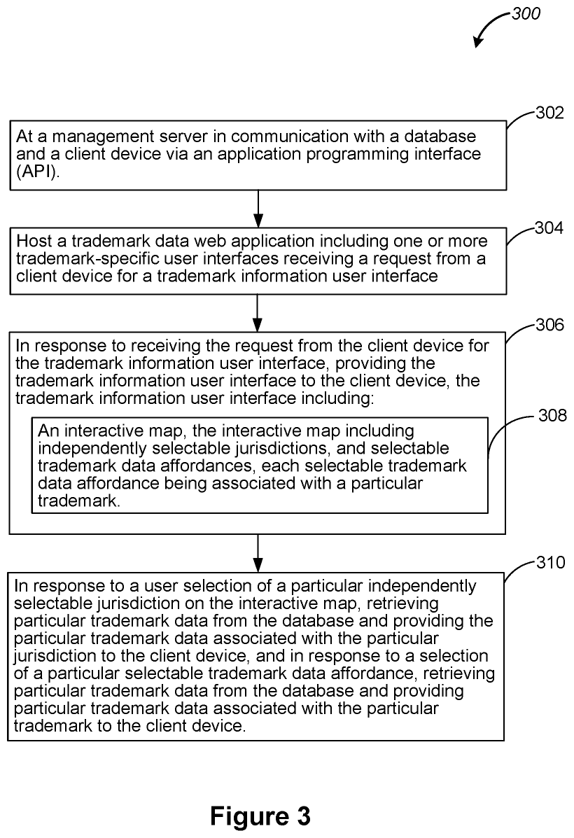

FIG. 3 shows a block diagram that illustrates a method 300 for storing, retrieving, and/or displaying intellectual property portfolio data according to at least some embodiments of the present invention. The method 300 may be performed by a management server (e.g., server 102 of FIG. 1), but in other embodiments one or more steps of the method may be performed by other components. Also, the exemplary embodiments shown in FIGS. 1 and 2A-2O may be referenced in the following description of the method 300 to illustrate one or more embodiments of the invention, but is intended to be non-limiting on any particular examples or embodiments.

At step 302, a management server may be in communication with a database (e.g., database 104 of FIG. 1) and a client device (e.g., client device 106 of FIG. 1) (e.g., via an API). The client device may include but is not limited to a personal computer and/or smartphone.

At step 304, an intellectual property-data web application (e.g., an intellectual property management application 120 in FIG. 1) hosted by the management server and including one or more intellectual property-specific user interfaces 118 may receive a request from a client device for a particular intellectual property information user interface 118, such as intellectual property information user interface 118 of FIG. 2A. The intellectual property information user interface 118 may include a user-fillable field 212 as shown in FIG. 2A. The intellectual property information user interface 118 may also include user-selectable criteria such as location 206, intellectual property owner 208, and/or intellectual property name 210. The intellectual property information user interface 118 may be equipped with a predictive typing drop-down window 214.

At step 306, the intellectual property information user interface 118 may be provided to the client device after receiving the request from the client device for intellectual property information. The intellectual property information user interface 118 may include owned intellectual properties 228, contested intellectual properties 230, the intellectual property owner 234, the intellectual property status 236, and/or the intellectual property licenses 238. The intellectual property information user interface 118 may include an interactive data visualization 216 with independently selectable jurisdictions.

At step 308, an interactive data visualization (e.g., interactive data visualization 216 of FIG. 2B) with independently selectable jurisdictions and selectable intellectual property data affordances may be displayed to the client device as shown in FIG. 2B. The interactive data visualization 216 may allow users to select a specific jurisdiction and view an overlay window 242 for the selected jurisdiction. The interactive data visualization 216 may allow a user to view an intellectual property information user interface 118 for a selected jurisdiction.

Stated another way, in some embodiments, the user interface 118 (e.g., FIG. 2B) includes an interactive geographical map 216 displaying independently selectable jurisdictions and selectable data affordances (e.g., “clickable rows” 240). Each selectable data affordance is associated with a respective intellectual property item.

At step 310, in response to a user selection of a particular independently selectable jurisdiction on the interactive data visualization, particular intellectual property data may be retrieved and provided to the client device as shown in FIG. 2E. The intellectual property information may include owned intellectual properties 228, contested intellectual properties 230, the intellectual property owner 234, the intellectual property status 236, and/or the intellectual property licenses 238. The intellectual property information user interface 118 may also include an interactive data visualization 216 with independently selectable jurisdictions.

At step 310, in response to a user selection of a particular independently selectable jurisdiction on the interactive data visualization, particular intellectual property data may be retrieved and provided to the client device as shown in FIG. 2C as an overlay window 242. The overlay window may include the particular intellectual property data as shown in FIG. 2C.

At step 310, in response to a user selection of a particular independently selectable jurisdiction on the interactive data visualization, particular intellectual property data may be retrieved and provided to the client device as shown in FIG. 2E. The particular intellectual property data may be displayed as a particular intellectual property data user interface 118 including the particular intellectual property data as shown in FIG. 2E. The intellectual property information user interface 118 may include owned intellectual properties 228, contested intellectual properties 230, the intellectual property owner 234, the intellectual property status 236, and/or the intellectual property licenses 238. The intellectual property information user interface 118 may include an interactive data visualization 216 with independently selectable jurisdictions.

At step 310, in response to a user selection of a particular independently selectable intellectual property data affordance, particular intellectual property data may be retrieved and provided to the client device as shown in FIG. 2O. The particular intellectual property data may be displayed as a particular intellectual property data user interface 118 including the particular intellectual property data as shown in FIG. 2O. The intellectual property information may include intellectual property name 254, intellectual property image 264, intellectual property application number 260, intellectual property registration number 262, intellectual property registration status 270, intellectual property filing date 266, intellectual property class 272, product type 273, and intellectual property licensing information 258.

In some embodiments, in response to a first user selection 312 of a first jurisdiction 314 (e.g., France in FIGS. 2C and 2D) on the interactive geographical map 216, information of a first set of intellectual property items 316 associated with the first jurisdiction 314 is extracted from the database 104, and provided to the client device 106 for display on a user interface 118 (e.g., FIGS. 2C and 2E) of the intellectual property management application 120. In response to a second user selection of a first selectable data affordance (e.g., those displayed on a clickable row 240 in FIG. 2H), information of a first intellectual property item 322 is extracted from the database 104, and provided to the client device 106 for display on the user interface 118 of the intellectual property management application 120. Referring to FIG. 2I, in an example, the information displayed for the first intellectual property item 322 include trademark name (“Peach Brands” 254), owner and location 256, licensing information 258, an application number 260, a registration number 262, features images 264, a filing date 266, a registration date 268, a status indicator 270, a class identifier 272, and a goods classification identifier 273.

In some embodiments, in response to the first user selection 312 (e.g., a cursor staying on a map area corresponding to “France” without clicking on the map area in FIG. 2C), the client device 106 is caused to display the information of the first set of intellectual property items 316 associated with the first jurisdiction 314 within an overlay window 242 of the user interface 118. The information of the first set of intellectual property items 316 includes a summary of the set of intellectual property items 316 associated with the first jurisdiction 314. Alternatively, in some embodiments, in response to the first user selection 312 (e.g., associated with a double-click action on the map area corresponding to “France” in FIG. 2D), the client device 106 is caused to display an intellectual property data interface (e.g., FIG. 2E) including the information of the first set of intellectual property items 316 associated with the first jurisdiction 314.

In some embodiments, the client device 106 detects one of a first user action 312A (e.g., a cursor pause in FIG. 2B) and a second user action 312B (e.g., a double click in FIG. 2D) indicative of the first user selection 312. The second user action 312B is separate and distinct from the first user action 312A. In response to detection of the one of the first user action 312A and the second user action 312B, a respective operation is implemented to cause the client device 106 to display the information of the first set of intellectual property items 316 associated with the first jurisdiction 314 on an overlay window 242 (e.g., in FIG. 2C) of the user interface in response to the first user action 312A or on an intellectual property data interface (e.g., in FIG. 2E) in response to the second user action 312B.

In some embodiments, referring to FIGS. 2C-2H, the information of the first set of intellectual property items 316 associated with the first jurisdiction 314 provided to the client device 106 includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.

In some embodiments, referring to FIG. 2I, the information of the first intellectual property item 322 includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.

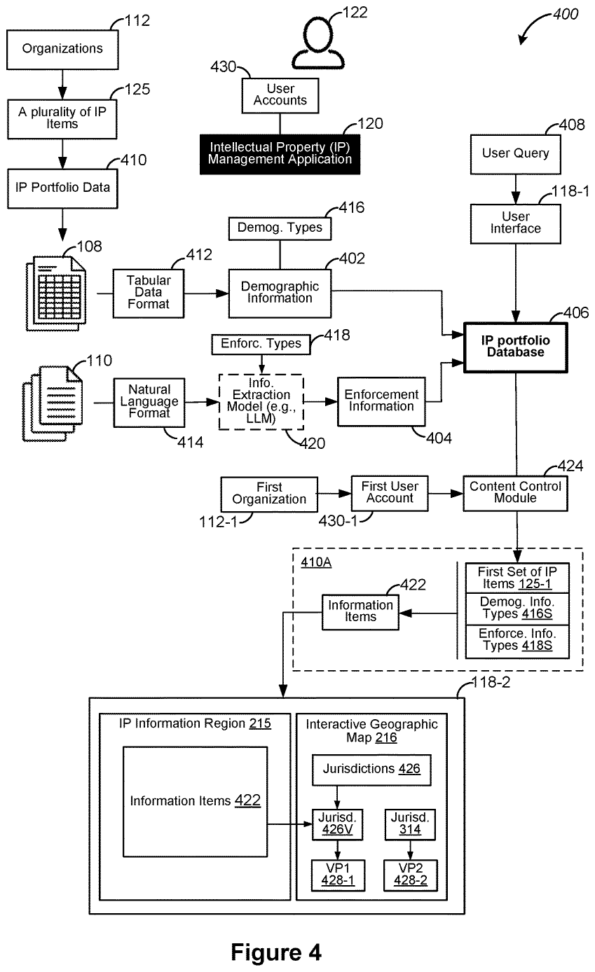

FIG. 4 is an example flow diagram of an example process 400 for managing intellectual property portfolio data 410 of a plurality of data items 125, in accordance with some embodiments. The process 400 is executed in a computer system (e.g., a server 102, client devices 106, a database 104, or a combination thereof), and the computer system includes one or more processors and memory storing one or more programs to be executed by the one or more processors. The computer system executes an intellectual property management application 120 for managing the intellectual property portfolio data 410 of the plurality of intellectual property items 125 of one or more organizations 112, and displays a user interface 118 via the intellectual property management application 120. The computer system consolidates demographic information 402 and enforcement information 404 of the plurality of intellectual property items in an intellectual property portfolio database 406. A client device 106 associated with a user 122 receives a user query 408 to the intellectual property portfolio database 406 on a first user interface 118-1 (e.g., in FIG. 2A). The user 122 is associated with a particular organization 122. In response to the user query 408, the server 102 causes the client device 106 to display a subset of intellectual property portfolio data 410A of the particular organization 112 associated with the client device 106 concurrently with an interactive data visualization 216 (FIG. 2B) of the subset of intellectual property portfolio data 410A. The user query 408 is applied to select a subset of the plurality of intellectual property items 125 and data types of the selected intellectual property items 125 as the subset of intellectual property portfolio data 410A.

In some embodiments, the computer system establishes the intellectual property portfolio database 406 based on one or more first files 108 having a tabular data format 412 and a plurality of second files 110 having a natural language format 414. The demographic information 402 of the plurality of intellectual property items 125 is imported from one or more first files 108 having the tabular data format 412, and the demographic information 402 of each intellectual property item 125 has a plurality of demographic data items corresponding to a plurality of demographic information types 416 (e.g., application number, title, description, keywords, expiration date, jurisdiction/location, filing date, issue/registration date, class, goods, intellectual property status, applicant, inventor, assignee, trademark image, patent claim 1). The enforcement information 404 of the plurality of intellectual property items 125 has a plurality of enforcement information types 418 (e.g., licensee, litigation, licensing territory, non-compete restriction, legal actions), and is extracted from the plurality of second files 110 associated with the plurality of intellectual property items 110 based on the plurality of enforcement information types 418.

In some embodiments, the enforcement information 404 of the plurality of intellectual property items 125 are extracted manually from the plurality of second files 110, when a user reviews the plurality of second files 110. Alternatively, in some embodiments, a second file 110 includes one of a license agreement and an assignment agreement of a respective organization. Automatically and without user intervention, the computer system applies an information extraction model 420 to receive at least the plurality of enforcement information types 418 as inputs and extract the enforcement information 404 of one or more of the intellectual property items corresponding to the plurality of enforcement information types 418. In an example, the computer system recognizes textual content in the second file 110, creates a query including the enforcement information types 418 and textual content, and applies a large language model (LLM) to extract relevant enforcement information 404 from the second file 110.

In some embodiments, after the computer system receives the user query 408 to the relationship database 406, the computer system selects a first set of intellectual property items 125-1 among the plurality of intellectual property items 125, identifies a subset of demographic information types 416S and a subset of enforcement information types 418S, and selects a set of information items 422 of the first set of intellectual property items 125-1 based on the subset of demographic information types 416S and the subset of enforcement information types 418S. More specifically, a content control module 424 (also called an information filter) selects the first set of intellectual property items 125-1 based on an access right of a user account 430-1 associated with the user query 408, e.g., allowing a client to review intellectual property portfolio data of intellectual property items owned or licensed to the client. The content control module 424 determines the information types 416S and 418S based on the user query 408, thereby limiting a scope of the information items 422 presented to the user and enhancing a data relevance level of the information items 422.

In response to the user query 408, the computer system concurrently displays, on a second user interface 118-2, at least an intellectual property information region 215 (FIG. 2B) including the set of information items 422 of the first set of intellectual property items 125-1 (e.g., in a tabular view) and a map region including an interactive geographical map 216 showing a plurality of jurisdictions 426 (e.g., covering all European countries). One or more jurisdictions 426V are associated with the first set of intellectual property items 125-1, and highlighted on the interactive geographical map 216 based on the set of information items 422 of the first set of intellectual property items 125-1. Referring back to FIG. 2B, the user query 408 requests trademarks registered in European Union. A list of trademarks are displayed in the intellectual property information region 215 with associated information of trademark names, owners, status, and licensee, while individual countries where the trademarks are registered are highlighted in the interactive geographical map 216, which is displayed immediately adjacent to the intellectual property information region. Further, in some embodiments, the intellectual property information region 215 includes a column corresponding to intellectual property item status (e.g., “registered,” “pending”), and each status value is represented in a distinct color (e.g., blue for “registered,” red for “pending”) on the user interface.

In some embodiments, the user query 408 includes a selection of one of a plurality of predefined search themes (e.g., “Location,” “Owner,” and “Name”) and a user-inputted keyword associated with the one of the plurality of predefined search themes. The computer system receives, on the user interface 118-1 (e.g., shown in FIG. 2A), a user action on a plurality of theme affordances (e.g., affordances 206, 208, and 210 in FIG. 2A) and a user input of the user-inputted keyword. For example, an intellectual property search tool bar 212 receives the user-inputted keyword Examples of keywords include, but are not limited to, “European,” “Peach Brands,” “Peach Fruits,” and “Best.” The user-inputted keyword may include a subset or all of full text of a search criterion. The user may enter “European” or “European Union” as a keyword. Both the subset and all of the full text of the search criterion may provide search enhancement, compared with no keyword being applied.

In some embodiments, the one or more jurisdictions 426V are visually highlighted on the interactive geographical map 216 according to a first pattern setting 428-1. While displaying the interactive geographical map 216 and visually highlighting the one or more jurisdictions 426V, the computer system detects a user interaction 312 (FIGS. 2B and 2D) with a first map area corresponding to a first jurisdiction 314 (e.g., France) and visually highlights the first jurisdiction 314 according to a second pattern setting 428-2. In an example, referring back to FIGS. 2B and 2D, the first pattern setting 428-1 and the second pattern setting 428-2 correspond to two different shades of a predefined color. The first pattern setting 428-1 corresponds to a first shade of a color, and the second pattern setting 428-2 corresponds to a second shade of the color, which is darker or lighter from the first shade of the color. Examples of the user interaction 312 include, but are not limited to, a cursor staying on top of the first map area (e.g., for an extended duration of time), a single click, and a double click.

In some embodiments, the computer system detects a user interaction with a first map area corresponding to a first jurisdiction 314 (e.g., a cursor pausing on the first map area in FIG. 2B). In response to detection of the user interaction, the second user interface 118-2 displays a summary of the first set of intellectual property items 125-1 with respect to the first jurisdiction 314 in an overlay window 242 partially overlapping the interactive geographical map 216. In some embodiments, the computer system detects a user interaction 312B with a first map area corresponding to a first jurisdiction 314 (e.g., a double click on the first map area in FIG. 2D). Referring back to FIG. 2E, in response to detection of the user interaction, the computer system updates the user interface 118-2 to concurrently display a subset of the set of information items 422 of the first set of intellectual property items 125-1 corresponding to the first jurisdiction on the intellectual property information region 215, as well as the interactive geographical map 216 including the first jurisdiction 314 on the map region. The first map area corresponding to the first jurisdiction 314 is visually highlighting the on the interactive geographical map 216.

Referring to FIG. 2G, in some embodiments, the computer system updates the user interface 118-2 to display enforcement information 404 (e.g., enforcement territory, non-compete restrictions, and actions) associated with the first set of intellectual property items 125-1 corresponding to the first jurisdiction 314 on the intellectual property information region 215. In some embodiments, the enforcement information 404 further includes information identifying U.S. business-prohibited countries, and the user interface 118-2 may display a banner or a notice including the information identifying U.S. business-prohibited countries.

In some embodiments, the computer system determines the plurality of jurisdictions 426V corresponding to the first set of intellectual property items. The first set of intellectual property items 125-1 may be registered in one or more jurisdictions 426V, and the plurality of jurisdiction 426V include all of the one or more jurisdiction 426V. A zoom factor is automatically selected for displaying the interactive geographical map 216, such that all of the one or more jurisdiction 426V are fully included in the interactive geographical map 216. Referring back to FIG. 2B, the zoom factor is chosen such that all of the European Union countries having registered trademarks associated with the user account 430-1 are displayed in the interactive geographical map 216. Irrelevant countries (e.g., Russia, Norway, United Kingdom, Ireland) are displayed without being highlighted. Alternatively, in some embodiments, the interactive geographical map 216 includes a worldwide map, and a plurality of business-prohibited territories may be visually highlighted on the interactive data visualization 216.

In some embodiments, the intellectual property management application 120 includes a plurality of user accounts 430, and each organization 112 corresponds to a respective subset of the plurality of intellectual property items 125 and a subset of the plurality of user accounts 430 having access limited to the respective subset of the plurality of intellectual property items. In some embodiments, the user query 408 is received from a first user account 430-1 associated with a first user of a first organization 112-1, and the first set of intellectual property items 125-1 are identified within the respective subset of the plurality of intellectual property items 125 corresponding to the first organization 112-1. In some embodiments, a user (e.g., an attorney) may have access to a set of two or more organizations 112. When the user logs onto the intellectual property management application 120, a multi-organization menu may be displayed to allow the user to select a target organization (e.g., the first organization 112-1) from the multi-organization menu, before continuing to enter the user query 408 on the first user interface 118-1 (e.g., shown in FIG. 2A).

In some embodiments, the one or more first files 108 are generated by a first user application (e.g., another intellectual property management application, a spreadsheet application), and the plurality of second files 110 are generated by a second user application (e.g., a word editing application). The first user application, the second user application, and the intellectual property management application are distinct from one another.

In some embodiments, the computer system imports the demographic information 402 of the plurality of intellectual property items 125 from the one or more first files 108. The computer system obtains an intellectual property item search query (e.g. including an assignee set to the first organization 112-1), searches an intellectual property database based on the intellectual property item search query, and downloads a search result including the one or more first files 108 from the intellectual property database. In some embodiments, the intellectual property database is one of a public intellectual property asset database (e.g., a patent office patent database, a trademark office trademark database) and a private intellectual property asset database. For example, the private intellectual property asset database is a local database maintained by a law firm on a law firm server 102C (FIG. 1) or by a service company on a third party application server 102B (FIG. 1). In some embodiments, the demographic information 402 is collected from a state level record.

Some implementations of this application are directed to creating an information management platform to collect, process, manage, and visualize a large volume of complex intellectual property data, which cannot be accomplished by human. Particularly, machine learning may be applied to analyze complex legal agreements (e.g., license agreement, assignment), extract enforcement information from legal documents, and visualize such information items in a user friendly manner. As such, some implementations of this application offer solutions to expand computer capabilities beyond conventional data computational and storage functions to mimic human capabilities of analyzing complex and abstract legal information having a natural language format and further visualize the legal information if needed.

FIG. 5A is a block diagram of an example management server 102 for managing intellectual property portfolio data for a plurality of organizations 112, in accordance with some embodiments. The management server 102 may be coupled to, or include a database 104. The management server 102 typically includes one or more processing units (e.g., CPUs) 502, one or more communication interfaces 504, memory 506, and one or more communication buses 508 for interconnecting these components (sometimes called a chipset). In some embodiments, the management server 102 includes a user interface system that further includes one or more input devices 512 that facilitate user input or one or more output devices 514 including a display that enable presentation of user interfaces (e.g., interface 118 in FIGS. 1 and 2A-2°) and display content.

Memory 506 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 506, optionally, includes one or more storage devices remotely located from one or more processing units 502. Memory 506, or alternatively the non-volatile memory within memory 506, includes a non-transitory computer readable storage medium. In some embodiments, memory 506, or the non-transitory computer readable storage medium of memory 506, stores the following programs, modules, and data structures, or a subset or superset thereof:
Operating system 510 including procedures for handling various basic system services and for performing hardware dependent tasks;
Network communication module 516 for connecting each server 102 to other devices (e.g., server 102, client device 106, or database 104) via one or more communication interfaces 504 (wired or wireless) and one or more communication networks 114 (FIG. 1), such as the Internet, other wide area networks, local area networks, metropolitan area networks, and so on;
User interface module 518 for enabling presentation of information (e.g., a graphical user interface for an application, widgets, websites and web pages thereof, and/or games, audio and/or video content, text, etc.) at each client device 106 via one or more output devices 514 (e.g., displays, speakers, etc.);
Input processing module 520 for detecting one or more user inputs or interactions from one of the one or more input devices 512 and interpreting the detected input or interaction;
Web browser module 522 for navigating, requesting (e.g., via HTTP), and displaying websites and web pages thereof;
Server-side intellectual property management application 120 for execution by the management server 102 to collect, process, and visualize intellectual property portfolio data associated with a plurality of intellectual property items 125, where the server-side information management application 120 further includes one or more of a data collection module 124 for collecting data associated with a plurality of intellectual property items 125 and having different data formats, a data processing module 126 for processing data associated with the plurality of intellectual property items 125, a machine learning module 128 for training and applying machine learning models, and a data visualization engine 130 for presenting the data of the intellectual property items 125 on a user interface 118;
One or more databases 104 for storing at least data including one or more of:
   Device settings 524 including common device settings (e.g., service tier, device model, storage capacity, processing capabilities, communication capabilities, etc.) of a server 102;
   User account information 526 for the intellectual property management application 120, e.g., user names, security questions, account history data, user preferences, and predefined account settings;
   Data sources 528 for providing intellectual property portfolio data of the plurality of intellectual property items 125, where in some embodiments, the data sources 528 include one or more first files 108 providing demographic information of the intellectual property items 125 in a tabular data format and one or more second files 110 (e.g., agreements) providing enforcement information of the intellectual property items in a natural language format;
   intellectual property portfolio database 406 including information of the intellectual property items 125, where the information includes demographic information 402 describing characteristics of the intellectual property items and enforcement information 404 extracted from second files 110 regarding enforcement of the intellectual property items 125.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 506, optionally, stores a subset of the modules and data structures identified above. Furthermore, memory 506, optionally, stores additional modules and data structures not described above.

FIG. 5B is a block diagram of an example client device 106 for interacting with a user to receive user queries and present intellectual property portfolio data, in accordance with some embodiments. The client device 106 typically includes one or more processing units (e.g., CPUs) 552, one or more communication interfaces 554, memory 556, and one or more communication buses 558 for interconnecting these components (sometimes called a chipset). The client device 106 includes one or more input devices 562 that facilitate user input or one or more output devices 564 including a display that enables presentation of user interfaces (e.g., interfaces 118 in FIGS. 1-2O) and display content.

Memory 556 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 556, optionally, includes one or more storage devices remotely located from one or more processing units 552. Memory 556, or alternatively the non-volatile memory within memory 556, includes a non-transitory computer readable storage medium. In some embodiments, memory 556, or the non-transitory computer readable storage medium of memory 556, stores the following programs, modules, and data structures, or a subset or superset thereof:
Operating system 560 including procedures for handling various basic system services and for performing hardware dependent tasks;
Network communication module 562 for connecting each device 106 to other devices (e.g., server 102, client device 106, or database 104) via one or more communication interfaces 554 (wired or wireless) and one or more communication networks 114;
User interface module 568 for enabling presentation of information at each client device 106 via one or more output devices 564 (e.g., displays, speakers, etc.);
Input processing module 570 for detecting one or more user inputs or interactions from one of the one or more input devices 562 and interpreting the detected input or interaction;
Web browser module 572 for navigating, requesting (e.g., via HTTP), and displaying websites and web pages thereof;
Client-side intellectual property management application 120 for execution by the client device 106 to collect, process, and visualize intellectual property portfolio data associated with a plurality of intellectual property items 125, where the client-side information management application 120 further includes one or more of user interfaces 118 on which user queries 580 are received and information of the plurality of intellectual property items 125 is presented and visualized, a data visualization engine 574 for visualizing the data of the intellectual property items 125 on a user interface 118 based on visual specifications 576;
One or more databases 578 for storing at least data including one or more of:
   Device settings 582 including common device settings (e.g., service tier, device model, storage capacity, processing capabilities, communication capabilities, etc.) of the client device 106;
   User account information 584 for the intellectual property management application 120, e.g., user names, security questions, account history data, user preferences, and predefined account settings; and
   Intellectual property application data 586 for storing data of the plurality of intellectual property items 125 and machine learning model(s) locally in support of execution of the intellectual property management application 120.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 556, optionally, stores a subset of the modules and data structures identified above. Furthermore, memory 556, optionally, stores additional modules and data structures not described above.

FIG. 5C is a block diagram of an example data structure 500 of intellectual property portfolio data stored in an intellectual property portfolio database 406, in accordance with some embodiments. In some embodiments, the intellectual property portfolio include demographic information 402 and enforcement information 404 (FIG. 5A) of a plurality of intellectual property items 125. The demographic information 402 includes characteristics of the intellectual property items 125 imported from one or more first files 108 (FIG. 1) each having a tabular format, e.g., using an API. The enforcement information 404 is extracted from a plurality of second files 110 (FIG. 1) associated with enforcement of the plurality of intellectual property items 125. In an example, one of the plurality of second files 110 includes a license agreement that has a natural language format and grants a right to sale of a subset of intellectual property items in a licensing territory (e.g., EP) for a licensing duration of time (e.g., 5 years starting from Jan. 1, 2024).

In some embodiments, the demographic information 402 of each of the plurality of intellectual property items 125 includes one or more of: application number 534, title 535, description 536, keywords 537, expiration date 538, jurisdiction/location 539, filing date 540, issue/registration date 543, class 543, goods 544, intellectual property status 545, applicant 546, inventor 547, assignee 548, trademark image 549, and one or more representative patent claims 550 of a respective intellectual property item. In some embodiments, the enforcement information 404 of each of the plurality of intellectual property items 125 includes one or more of: licensee 590, litigation history 591, licensing territory 592, consent and coexistence agreement 593, non-compete restriction 594, oppositions 595, and cancellation and challenge 596.

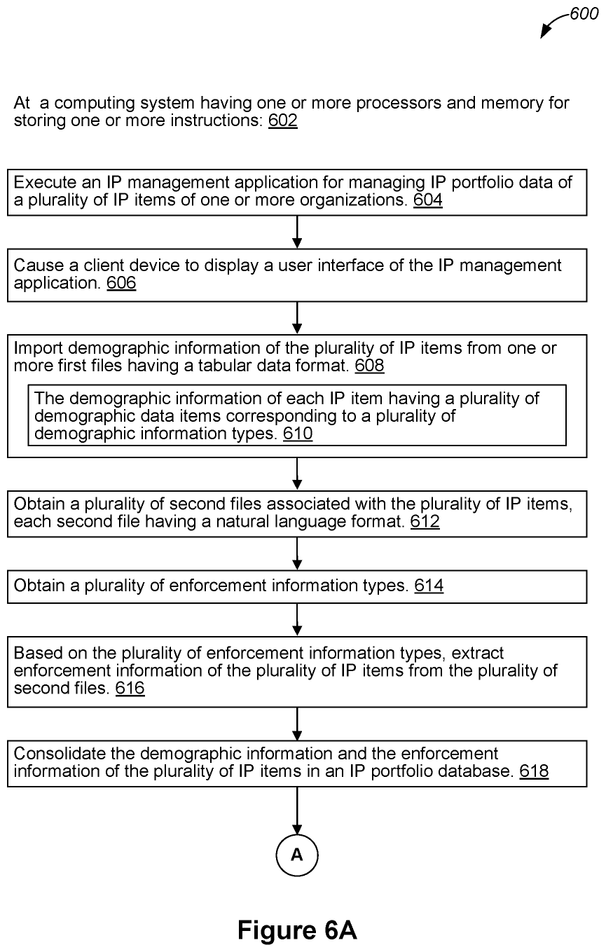

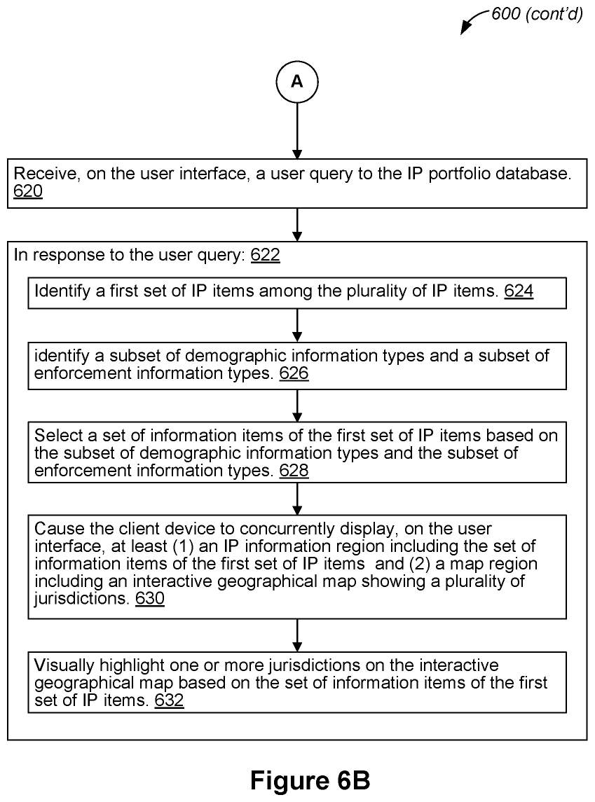

FIGS. 6A and 6B is a flow diagram of an example method 600 for managing intellectual property portfolio data of a plurality of intellectual property items 120 of an organization 112, in accordance with some embodiments. For convenience, the method 600 is described as being implemented by a system. Method 600 is, optionally, governed by instructions that are stored in a non-transitory computer readable storage medium and that are executed by one or more processors of the system. Each of the operations shown in FIGS. 6A and 6B may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 600 may be combined and/or the order of some operations may be changed.

The method 600 is implemented (operation 602) at a computer system (e.g., a server 102) having one or more processors and memory for storing one or more instructions. The computer system executes (operation 604) an intellectual property management application 120 for managing intellectual property portfolio data of a plurality of intellectual property items 125 of one or more organizations 112, and causes a client device 106 to display (operation 606) a user interface 118 of the intellectual property management application 120. The computer system import (operation 608) demographic information 402 of the plurality of intellectual property items 125 from one or more first files 108 having a tabular data format 412, e.g., using an API. The demographic information 402 of each intellectual property item has (operation 610) a plurality of demographic data items corresponding to a plurality of demographic information types 416. The computer system obtains (operation 612) a plurality of second files 110 associated with the plurality of intellectual property items 125, each second file having a natural language format 414, and determines (operation 614) a plurality of enforcement information types 418. Based on the plurality of enforcement information types 418, the computer system extracts (operation 616) enforcement information 404 of the plurality of intellectual property items 125 from the plurality of second files 110, and consolidates (operation 618) the demographic information 402 and the enforcement information 404 of the plurality of intellectual property items 125 in an intellectual property portfolio database 406.

The computer system receives (operation 620), on the user interface 118, a user query 408 to the intellectual property portfolio database 406. In response to the user query 408 (operation 622), the computer system identifies (operations 624 and 626) a first set of intellectual property items 125-1 among the plurality of intellectual property items 125, a subset of demographic information types 416, and a subset of enforcement information types 418. A set of information items 422 of the first set of intellectual property items 125-1 are selected (operation 628) based on the subset of demographic information types 416 and the subset of enforcement information types 418. The computer system causes (operation 630) a client device to concurrently display, on the user interface 118, at least (1) an intellectual property information region including the set of information items 422 of the first set of intellectual property items 125-1 and (2) a map region including an interactive geographical map 216 showing a plurality of jurisdictions 426. One or more jurisdictions 314 are visually highlighted (operation 632) on the interactive geographical map 216 based on the set of information items 422 of the first set of intellectual property items 125-1. More details on managing intellectual property portfolio data of intellectual property items 120 of an organization 112 are discussed above with reference to FIGS. 1-4.

Memory is also used to store instructions and data associated with the method 600, and includes high-speed random access memory, such as DRAM, SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 600.

Some implementations of this application are described in the following clauses:
Clause 1. A method of managing and visually displaying intellectual property portfolio data to a user, the method comprising: at a management server in communication with a database and a client device; hosting an intellectual property-data web application including one or more intellectual property-specific user interfaces; receiving a request from a client device for an intellectual property information user interface; in response to receiving the request from the client device for the intellectual property information user interface, providing the intellectual property information user interface to the client device, the intellectual property information user interface including: an interactive data visualization, the interactive data visualization including independently selectable jurisdictions, and selectable intellectual property data affordances, each selectable intellectual property-data affordance being associated with a particular intellectual property; in response to a user selection of a particular independently selectable jurisdiction on the interactive data visualization, retrieving particular intellectual property data from the database and providing the particular intellectual property data associated with the particular jurisdiction to the client device, and in response to a selection of a particular selectable intellectual property-data affordance, retrieving particular intellectual property data from the database and providing particular intellectual property data associated with the particular intellectual property to the client device.
Clause 2. The method of clause 1, wherein displaying the particular intellectual property data associated with the particular jurisdiction includes displaying an overlay window including the particular intellectual property data.
Clause 3. The method of clause 1 or 2, wherein displaying the particular intellectual property data associated with the particular jurisdiction includes providing a particular intellectual property data user interface including the particular intellectual property data.
Clause 4. The method of any of clauses 1-3, wherein displaying the particular intellectual property data associated with the particular jurisdiction includes displaying an overlay window including the particular intellectual property data in response to a first user action indicative of the user selection, and wherein displaying the particular intellectual property data associated with the particular jurisdiction includes providing a particular intellectual property data user interface including the particular intellectual property data in response to a second user action indicative of the user selection, wherein the section user action is separate and distinct from the first user action.
Clause 5. The method of any of clauses 1-4, wherein the particular intellectual property data associated with the particular jurisdiction provided to the client device in response to a selection of a particular selectable jurisdiction includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.
Clause 6. The method of any of clauses 1-5, wherein the particular intellectual property data associated with the particular intellectual property provided to the client device in response to a selection of a particular selectable intellectual property data affordance includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.
Clause 7. The method of any of clauses 1-6, further comprising: providing an intellectual property search interface configured to allow a user to request particular intellectual property information, the intellectual property search interface including a search bar and selectable intellectual property criteria including entity, intellectual property name and location; and in response to a user input provided in the search bar and a user selection of one of the intellectual property criteria, providing a particular intellectual property information user interface specific to the user input and user selection.
Clause 8. A system of managing and visually displaying intellectual property portfolio data to a user, the system comprising: a management server in communication with a database and a client device, the management server configured to perform the steps of: hosting an intellectual property-data web application including one or more intellectual property-specific user interfaces; receiving a request from a client device for an intellectual property information user interface; in response to receiving the request from the client device for the intellectual property information user interface, providing the intellectual property information user interface to the client device, the intellectual property information user interface including: an interactive data visualization, the interactive data visualization including independently selectable jurisdictions, and selectable intellectual property data affordances, each selectable intellectual property-data affordance being associated with a particular intellectual property data; in response to a user selection of a particular independently selectable jurisdiction on the interactive data visualization, retrieving particular intellectual property data from the database and providing the particular intellectual property data associated with the particular jurisdiction to the client device, and in response to a selection of a particular selectable intellectual property-data affordance, retrieving particular intellectual property data from the database and providing particular intellectual property data associated with the particular intellectual property to the client device.
Clause 9. The system of clause 8, wherein displaying the particular intellectual property data associated with the particular jurisdiction includes displaying an overlay window including the particular intellectual property data.
Clause 10. The system of clause 8 or 9, wherein displaying the particular intellectual property data associated with the particular jurisdiction includes providing a particular intellectual property data user interface including the particular intellectual property data.
Clause 11. The system of any of clauses 8-10, wherein displaying the particular intellectual property data associated with the particular jurisdiction includes displaying an overlay window including the particular intellectual property data in response to a first user action indicative of the user selection, and wherein displaying the particular intellectual property data associated with the particular jurisdiction includes providing a particular intellectual property data user interface including the particular intellectual property data in response to a second user action indicative of the user selection, wherein the section user action is separate and distinct from the first user action.
Clause 12. The system of any of clauses 8-11, wherein the particular intellectual property data associated with the particular jurisdiction provided to the client device in response to a selection of a particular selectable jurisdiction includes at least one of: trademark name, trademark image, trademark application number, trademark registration number, trademark registration status, trademark filing date, trademark class, product type, and trademark licensing information.
Clause 13. The system of any of clauses 8-12, wherein the particular intellectual property data associated with the particular intellectual property data provided to the client device in response to a selection of a particular selectable intellectual property data affordance includes at least one of: trademark name, trademark image, trademark application number, trademark registration number, trademark registration status, trademark filing date, trademark class, product type, and trademark licensing information.
Clause 14. The system of any of clauses 8-13, wherein the management system is further configured to perform the steps of: providing an intellectual property data search interface configured to allow a user to request particular intellectual property information, the intellectual property data search interface including a search bar and selectable intellectual property data criteria including entity, trademark name and location; and in response to a user input provided in the search bar and a user selection of one of the intellectual property data criteria, providing a particular intellectual property information user interface specific to the user input and user selection.
Clause 15. A computer implemented method for managing intellectual property information, comprising: at a computer system having one or more processors and memory for storing one or more instructions: executing an intellectual property management application for managing intellectual property portfolio data of a plurality of intellectual property items of one or more organizations; causing a client device to display a user interface of the intellectual property management application; importing demographic information of the plurality of intellectual property items from one or more first files having a tabular data format, the demographic information of each intellectual property item having a plurality of demographic data items corresponding to a plurality of demographic information types; obtaining a plurality of second files associated with the plurality of intellectual property items, each second file having a natural language format; obtaining a plurality of enforcement information types; based on the plurality of enforcement information types, extracting enforcement information of the plurality of intellectual property items from the plurality of second files; consolidating the demographic information and the enforcement information of the plurality of intellectual property items in an intellectual property portfolio database; receiving, on the user interface, a user query to the intellectual property portfolio database; in response to the user query: identifying a first set of intellectual property items among the plurality of intellectual property items; identifying a subset of demographic information types and a subset of enforcement information types; selecting a set of information items of the first set of intellectual property items based on the subset of demographic information types and the subset of enforcement information types; causing the client device to concurrently display, on the user interface, at least (1) an intellectual property information region including the set of information items of the first set of intellectual property items and (2) a map region including an interactive geographical map showing a plurality of jurisdictions; and visually highlighting one or more jurisdictions on the interactive geographical map based on the set of information items of the first set of intellectual property items.
Clause 16. The method of clause 15, wherein the user query includes a selection of one of a plurality of predefined search themes and a user-inputted keyword associated with the one of the plurality of predefined search themes, the method further comprising: receiving, on the user interface, a user action on a plurality of theme affordances and a user input of the user-inputted keyword.
Clause 17. The method of clause 15 or 16, wherein the one or more jurisdictions are visually highlighted on the interactive geographical map according to a first pattern setting, the method further comprising, while displaying the interactive geographical map and visually highlighting the one or more jurisdictions on the interactive geographical map: detecting a user interaction with a first map area corresponding to a first jurisdiction; and in response to detection of the user interaction, visually highlighting the first jurisdiction according to a second pattern setting.
Clause 18. The method of clause 17, wherein the first pattern setting and the second pattern setting correspond to two different shades of a predefined color.
Clause 19. The method of any of clauses 15-18, comprising: detecting a user interaction with a first map area corresponding to a first jurisdiction; and in response to detection of the user interaction, displaying a summary of the first set of intellectual property items with respect to the first jurisdiction in an overlay window partially overlapping the interactive geographical map.
Clause 20. The method of any of clauses 15-18, comprising: detecting a user interaction with a first map area corresponding to a first jurisdiction; and in response to detection of the user interaction, updating the user interface to concurrently display (1) a subset of the set of information items of the first set of intellectual property items corresponding to the first jurisdiction on the intellectual property information region and (2) the interactive geographical map including the first jurisdiction on the map region, and visually highlighting the first map area on the interactive geographical map.
Clause 21. The method of any of clauses 15-20, further comprising: determining the plurality of jurisdictions corresponding to the first set of intellectual property items; and automatically selecting a zoom factor for displaying the interactive geographical map.
Clause 22. The method of any of clauses 15-21, wherein the intellectual property management application includes a plurality of user accounts, and each organization corresponds to a respective subset of the plurality of intellectual property items and a subset of user accounts having access limited to the respective subset of the plurality of intellectual property items.
Clause 23. The method of any of clauses 15-22, wherein the user query is received from a first user account associated with a first user of a first organization, and the first set of intellectual property items are identified within the respective subset of the plurality of intellectual property items corresponding to the first organization.
Clause 24. The method of any of clauses 15-23, wherein one of the plurality of second files associated with the plurality of intellectual property items includes one of a license agreement and an assignment agreement of a respective organization, further comprising, automatically and without user intervention: recognizing textual content in the one of the plurality of second files; and applying an information extraction model to receive the textual content and the plurality of enforcement information types as inputs, identify a second set of intellectual property items associated with the respective organization and referenced in the textual content, and extract the enforcement information of the second set of intellectual property items corresponding to the plurality of enforcement information types.
Clause 25. The method of any of clauses 15-24, wherein the one or more first files are generated by a first user application, and the plurality of second files are generated by a second user application, and the first user application, the second user application, and the intellectual property management application are distinct from one another.
Clause 26. The method of any of clauses 15-25, wherein importing the demographic information of the plurality of intellectual property items from one or more first files further comprises: obtaining an intellectual property item search query; searching an intellectual property database based on the intellectual property item search query; and downloading a search result including the one or more first files from the intellectual property database.
Clause 27. The method of clause 26, wherein the intellectual property database is one of a public intellectual property asset database and a private intellectual property asset database.
Clause 28. A method of managing and visually displaying intellectual property portfolio data, comprising: at a computer system in communication with an intellectual property portfolio database and a client device: hosting an intellectual property management application including a user interface; receiving a request from a client device for the user interface; in response to the request received from the client device, causing the client device to display the user interface, the user interface including: an interactive geographical map, the interactive geographical map displaying independently selectable jurisdictions, and selectable data affordances, each selectable data affordance being associated with a respective intellectual property item; in response to a first user selection of a first jurisdiction on the interactive geographical map, retrieving information of a first set of intellectual property items associated with the first jurisdiction from the intellectual property portfolio database, and providing the information of the first set of intellectual property items associated with the first jurisdiction to the client device; and in response to a second user selection of a first selectable data affordance, retrieving information of a first intellectual property item from the intellectual property portfolio database, and providing the information of the first intellectual property item to the client device.
Clause 29. The method of clause 28, further comprising: in response to the first user selection, causing the client device to display the information of the first set of intellectual property items associated with the first jurisdiction within an overlay window of the user interface.
Clause 30. The method of clause 28 or 29, further comprising: in response to the first user selection, causing the client device to display an intellectual property data interface including the information of the first set of intellectual property items associated with the first jurisdiction.
Clause 31. The method of any of clauses 28-30, further comprising: detecting one of a first user action and a second user action indicative of the first user selection, wherein the second user action is separate and distinct from the first user action; and in response to detection of the one of the first user action and the second user action, implementing a respective operation selected from: causing the client device to display the information of the first set of intellectual property items associated with the first jurisdiction on an overlay window of the user interface in response to the first user action; and causing the client device to display the information of the first set of intellectual property items an intellectual property data interface in response to the second user action.
Clause 32. The method of any of clauses 28-31, wherein the information of the first set of intellectual property items associated with the first jurisdiction provided to the client device includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.
Clause 33. The method of any of clauses 28-32, wherein the information of the first intellectual property item includes at least one of: intellectual property name, intellectual property image, intellectual property application number, intellectual property registration number, intellectual property registration status, intellectual property filing date, intellectual property class, intellectual property good and/or service description, intellectual property maintenance filing deadlines and expiration dates, intellectual property oppositions, cancellations and challenges, intellectual property settlement, consent and coexistence agreements, and intellectual property licensing information.
Clause 34. The method of any of clauses 28-33, further comprising: causing the client device to display an intellectual property search interface for receiving a user request for intellectual property information, the intellectual property search interface including a search bar and a plurality of selectable intellectual property criteria including entity, intellectual property name, and location; and in response to a user input in the search bar and a third user selection of one of the plurality of intellectual property criteria, causing the client device to display an intellectual property information interface based on the user input and the third user selection.
Clause 35. A computer system, comprising: one or more processors; and memory having instructions stored thereon, which when executed by the one or more processors cause the processors to perform operations for performing a method in any of clauses 1-7 and 15-34.
Clause 36. A non-transitory computer-readable storage medium, having instructions stored thereon, which when executed by one or more processors of a computer system cause the processors to perform a method in any of clauses 1-7 and 15-34.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A computer implemented method for managing intellectual property information, comprising:
at a computer system having one or more processors and memory for storing one or more instructions:
executing an intellectual property management application for managing intellectual property portfolio data of a plurality of intellectual property items of one or more organizations;
causing a client device to display a user interface of the intellectual property management application;
importing demographic information of the plurality of intellectual property items from one or more first files having a tabular data format, the demographic information of each intellectual property item having a plurality of demographic data items corresponding to a plurality of demographic information types;
obtaining a plurality of second files associated with the plurality of intellectual property items, each second file having a natural language format;
obtaining a plurality of enforcement information types;
based on the plurality of enforcement information types, extracting enforcement information of the plurality of intellectual property items from the plurality of second files;
consolidating the demographic information and the enforcement information of the plurality of intellectual property items in an intellectual property portfolio database;
receiving, on the user interface, a user query to the intellectual property portfolio database; and
in response to the user query:
identifying a first set of intellectual property items among the plurality of intellectual property items;
identifying a subset of demographic information types and a subset of enforcement information types;
selecting a set of information items of the first set of intellectual property items based on the subset of demographic information types and the subset of enforcement information types;
causing the client device to concurrently display, on the user interface, at least (1) an intellectual property information region including the set of information items of the first set of intellectual property items and (2) a map region including an interactive geographical map showing a plurality of jurisdictions; and
visually highlighting one or more jurisdictions on the interactive geographical map based on the set of information items of the first set of intellectual property items.

2. The method of claim 1, wherein the user query includes a selection of one of a plurality of predefined search themes and a user-inputted keyword associated with the one of the plurality of predefined search themes, the method further comprising:
receiving, on the user interface, a user action on a plurality of theme affordances and a user input of the user-inputted keyword.

3. The method of claim 1, wherein the one or more jurisdictions are visually highlighted on the interactive geographical map according to a first pattern setting, the method further comprising, while displaying the interactive geographical map and visually highlighting the one or more jurisdictions on the interactive geographical map:
detecting a user interaction with a first map area corresponding to a first jurisdiction; and
in response to detection of the user interaction, visually highlighting the first jurisdiction according to a second pattern setting.

4. The method of claim 3, wherein the first pattern setting and the second pattern setting correspond to two different shades of a predefined color.

5. The method of claim 1, comprising:
detecting a user interaction with a first map area corresponding to a first jurisdiction; and
in response to detection of the user interaction, displaying a summary of the first set of intellectual property items with respect to the first jurisdiction in an overlay window partially overlapping the interactive geographical map.

6. The method of claim 1, comprising:
detecting a user interaction with a first map area corresponding to a first jurisdiction; and
in response to detection of the user interaction, updating the user interface to concurrently display (1) a subset of the set of information items of the first set of intellectual property items corresponding to the first jurisdiction on the intellectual property information region and (2) the interactive geographical map including the first jurisdiction on the map region, and visually highlighting the first map area on the interactive geographical map.

7. The method of claim 1, further comprising:
determining the plurality of jurisdictions corresponding to the first set of intellectual property items; and
automatically selecting a zoom factor for displaying the interactive geographical map.

8. The method of claim 1, wherein the intellectual property management application includes a plurality of user accounts, and each organization corresponds to a respective subset of the plurality of intellectual property items and a subset of user accounts having access limited to the respective subset of the plurality of intellectual property items.

9. The method of claim 1, wherein the user query is received from a first user account associated with a first user of a first organization, and the first set of intellectual property items are identified within the respective subset of the plurality of intellectual property items corresponding to the first organization.

10. The method of claim 1, wherein one of the plurality of second files associated with the plurality of intellectual property items includes one of a license agreement and an assignment agreement of a respective organization, further comprising, automatically and without user intervention:
recognizing textual content in the one of the plurality of second files; and
applying an information extraction model to receive the textual content and the plurality of enforcement information types as inputs, identify a second set of intellectual property items associated with the respective organization and referenced in the textual content, and extract the enforcement information of the second set of intellectual property items corresponding to the plurality of enforcement information types.

11. The method of claim 1, wherein the one or more first files are generated by a first user application, and the plurality of second files are generated by a second user application, and the first user application, the second user application, and the intellectual property management application are distinct from one another.

12. The method of claim 1, wherein importing the demographic information of the plurality of intellectual property items from one or more first files further comprises:
obtaining an intellectual property item search query;
searching an intellectual property database based on the intellectual property item search query; and
downloading a search result including the one or more first files from the intellectual property database.

13. The method of claim 12, wherein the intellectual property database is one of a public intellectual property asset database and a private intellectual property asset database.

14. A computer system, comprising:
one or more processors; and
memory having instructions stored thereon, which when executed by the one or more processors cause the processors to perform operations for performing operations comprising:
executing an intellectual property management application for managing intellectual property portfolio data of a plurality of intellectual property items of one or more organizations;
causing a client device to display a user interface of the intellectual property management application;
importing demographic information of the plurality of intellectual property items from one or more first files having a tabular data format, the demographic information of each intellectual property item having a plurality of demographic data items corresponding to a plurality of demographic information types;
obtaining a plurality of second files associated with the plurality of intellectual property items, each second file having a natural language format;
obtaining a plurality of enforcement information types;
based on the plurality of enforcement information types, extracting enforcement information of the plurality of intellectual property items from the plurality of second files;
consolidating the demographic information and the enforcement information of the plurality of intellectual property items in an intellectual property portfolio database;
receiving, on the user interface, a user query to the intellectual property portfolio database;
in response to the user query:
identifying a first set of intellectual property items among the plurality of intellectual property items;
identifying a subset of demographic information types and a subset of enforcement information types;
selecting a set of information items of the first set of intellectual property items based on the subset of demographic information types and the subset of enforcement information types;
causing the client device to concurrently display, on the user interface, at least (1) an intellectual property information region including the set of information items of the first set of intellectual property items and (2) a map region including an interactive geographical map showing a plurality of jurisdictions; and
visually highlighting one or more jurisdictions on the interactive geographical map based on the set of information items of the first set of intellectual property items.

15. The computer system of claim 14, wherein the user query includes a selection of one of a plurality of predefined search themes and a user-inputted keyword associated with the one of the plurality of predefined search themes, and the memory further stores instructions for:
receiving, on the user interface, a user action on a plurality of theme affordances and a user input of the user-inputted keyword.

16. The computer system of claim 14, wherein the one or more jurisdictions are visually highlighted on the interactive geographical map according to a first pattern setting, and the memory further stores instructions for, while displaying the interactive geographical map and visually highlighting the one or more jurisdictions on the interactive geographical map:
detecting a user interaction with a first map area corresponding to a first jurisdiction; and
in response to detection of the user interaction, visually highlighting the first jurisdiction according to a second pattern setting.

17. A non-transitory computer-readable storage medium, having instructions stored thereon, which when executed by one or more processors of a computer system cause the processors to perform operations comprising:
executing an intellectual property management application for managing intellectual property portfolio data of a plurality of intellectual property items of one or more organizations;
causing a client device to display a user interface of the intellectual property management application;
importing demographic information of the plurality of intellectual property items from one or more first files having a tabular data format, the demographic information of each intellectual property item having a plurality of demographic data items corresponding to a plurality of demographic information types;
obtaining a plurality of second files associated with the plurality of intellectual property items, each second file having a natural language format;
obtaining a plurality of enforcement information types;
based on the plurality of enforcement information types, extracting enforcement information of the plurality of intellectual property items from the plurality of second files;
consolidating the demographic information and the enforcement information of the plurality of intellectual property items in an intellectual property portfolio database;
receiving, on the user interface, a user query to the intellectual property portfolio database;
in response to the user query:
identifying a first set of intellectual property items among the plurality of intellectual property items;
identifying a subset of demographic information types and a subset of enforcement information types;
selecting a set of information items of the first set of intellectual property items based on the subset of demographic information types and the subset of enforcement information types;
causing the client device to concurrently display, on the user interface, at least (1) an intellectual property information region including the set of information items of the first set of intellectual property items and (2) a map region including an interactive geographical map showing a plurality of jurisdictions; and
visually highlighting one or more jurisdictions on the interactive geographical map based on the set of information items of the first set of intellectual property items.

18. The non-transitory computer-readable storage medium of claim 17, further comprising instructions for:
detecting a user interaction with a first map area corresponding to a first jurisdiction; and
in response to detection of the user interaction, displaying a summary of the first set of intellectual property items with respect to the first jurisdiction in an overlay window partially overlapping the interactive geographical map.

19. The non-transitory computer-readable storage medium of claim 17, further comprising instructions for:
detecting a user interaction with a first map area corresponding to a first jurisdiction; and
in response to detection of the user interaction, updating the user interface to concurrently display (1) a subset of the set of information items of the first set of intellectual property items corresponding to the first jurisdiction on the intellectual property information region and (2) the interactive geographical map including the first jurisdiction on the map region, and visually highlighting the first map area on the interactive geographical map.

20. The non-transitory computer-readable storage medium of claim 17, further comprising instructions for:
determining the plurality of jurisdictions corresponding to the first set of intellectual property items; and
automatically selecting a zoom factor for displaying the interactive geographical map.
